(19) United States
(12) Patent Application Publication
(10) Pub. No.: US 2013/0290208 A1
(43) Pub. Date: Oct. 31, 2013

(54) SOCIAL MEDIA DATA FILTERING FOR ELECTRONIC JOB RECRUITING

(71) Applicant: GILD, INC., San Francisco, CA (US)

(72) Inventors: Luca BONMASSAR, Marina di Massa (IT); Sheeroy DESAI, San Francisco, CA (US)

(73) Assignee: Gild, Inc., San Francisco, CA (US)

(21) Appl. No.: 13/739,381

(22) Filed: Jan. 11, 2013

Related U.S. Application Data
(63) Continuation-in-part of application No. 13/493,791, filed on Jun. 11, 2012.
(60) Provisional application No. 61/640,656, filed on Apr. 30, 2012.

(51) Int. Cl. G06Q 10/10

(52) U.S. Cl. CPC G06Q 10/1053
USPC 705/321

(57) ABSTRACT

A recruitment enhancement system is disclosed that can be used by job recruiters to assess job applicant's suitability for particular jobs. The recruitment enhancement system can maintain and regularly update a proprietary database including resume data and data gathered from social media sources for various individuals. The system can be configured to filter data before it is presented to a user. The filtering system can be configured such that only data “safe” for use in a hiring decision is presented about individuals. In one embodiment, the filtering can involve identifying protected class information for each individual and preventing its output via the system.

### CROSS-REFERENCE TO RELATED APPLICATIONS

The present application is a continuation-in-part and claims priority to U.S. patent application Ser. No. 13/493,791, filed Jun. 11, 2012, Bonmassar et al., entitled “RECRUITING SERVICE GRAPHICAL USER INTERFACE”, which claims the benefit of U.S. Provisional Application No. 61/640,656, filed Apr. 30, 2012, Bonmassar et al., entitled “RECRUITING SERVICE GRAPHICAL USER INTERFACE”, the contents of each of which are hereby incorporated by reference in their entirety and for all purposes.

### FIELD OF THE INVENTION

The present invention is generally related to employment recruitment tools. More particularly, the present invention is directed to providing recruitment services, such as providing information relevant to identifying candidates likely to be interested in considering new job opportunities and for determining the fit of a candidate to a job opportunity.

### BACKGROUND OF THE INVENTION

An applicant tracking system is a software application that enables the electronic handling of recruitment needs. Nearly all major corporations use some form of applicant tracking system to handle job applications and to manage resume data. The principal function of an applicant tracking system is to provide a central location and database for a company's recruitment efforts. Applicant tracking systems are built to better assist management of resumes and applicant information. Data can either be collected from internal applications via the applicant tracking system's front-end, located on the company website, or can be extracted from applicants on job boards.

Not long ago, job applicants often learned of available jobs advertised in printed media, such as newspapers or job posting boards, where written descriptions of jobs printed on paper were posted to the board. To apply for an available job, the job applicant typically submitted a resume on paper. For instance, to seek a job position available at a company, the job applicant would mail their resume to an address associated with a human resources department listed in the advertisement. After receiving the resume, a portion of the information from the resume was entered, often manually, into an applicant tracking system.

Today, the tasks described above are more and more being performed electronically. Jobs are advertised electronically and applicants submit their resumes electronically. The submission of the resume electronically allows for a larger set of information to be automatically transferred to the applicant tracking system, as compared to the process of manual entry from a paper resume. Some advantages of performing these recruiting tasks electronically are the ability to reach a greater pool of applicants, and the ability to obtain greater amounts of searchable data about the applicants.

In recruiting, at some point, a manual filtering process takes place. In the manual filtering process, recruiters select particular applicants for greater scrutiny, such as an interview. A disadvantage of performing the recruiting tasks electronically is that so much data can be received from so many different applicants, that the task of filtering the applicant data to determine which applicants to recruit becomes difficult and time consuming. For example, hundreds or even thousands of resumes can be received for a single job opening. As a result of the difficulties associated with filtering large amounts of applicant data received electronically, many opportunities for recruiting potentially valuable employees are lost because their information can't be separated from the vast pool of applicant data that is received. Thus, the value of electronic recruiting, such as enabled by applicant tracking systems, is greatly reduced.

Publically available data, such as data from social media sites, are sources of information that can be used in the hiring process and hence applied to filter out candidates. When gathered social media data is used in the hiring process, it is important to ensure the information is accurate and is used in a non-discriminatory manner that complies with hiring regulations. If gathered social media data is not used properly, a company can be exposed to law suits. In view of the above, new methods and apparatus for electronic recruiting are desired that ensure the proper use of aggregated publically available data.

### SUMMARY OF THE INVENTION

A recruitment enhancement system, method, and computer program product is disclosed that can be used by job recruiters to assess a job applicant's suitability for particular jobs. In one embodiment, a computer system includes a processor and a memory, and acquires social media content generated by an individual. The social media content can be obtained via crawling the web for publically available information, such as information available on social media sites. The information can be aggregated and then filtered. One objective of the filtering can be to present information that is safe to use in a hiring decision. For example, the aggregated data can be filtered to remove protected class information associated with federal regulations. In general, the filtering can be performed to prevent discriminatory hiring practices that conflict with federal regulations, such as hiring decisions based upon race, age or gender discrimination, while still allowing recruiters to learn additional information about individuals that can be safely used in a hiring process.

One aspect of the embodiments described herein is related to a method of electronic job recruiting in a system including a processor and memory. The method can be generally characterized as comprising training by the processor one or more filters to identify safe data, unsafe data or combinations thereof where the safe data is selected to be safe to use in a hiring decision, receiving by the processor hiring data from a plurality of data sources for a plurality of individuals where the hiring data includes resume data and social media data; aggregating by the processor the received hiring data for each individual; storing by the processor the aggregated hiring data for each individual to a database , wherein the individual's aggregated hiring data includes a plurality of different portions; receiving by the processor search parameters associated with a hiring decision; based upon the search parameters, locating by the processor at least one individual in the database that satisfy the search parameters; applying by the processor the one or more filters to each portion of the at least one individual's aggregated hiring data to identify safe or unsafe portions of the data; and outputting by the processor only the safe portions.

### BRIEF DESCRIPTION OF THE DRAWINGS

FIG. 1 is a block diagram of a recruitment ecosystem in accordance with an embodiment of the present invention.

FIG. 2 is a block diagram of a recruitment enhancement system in accordance with an embodiment of the present invention.

FIG. 3 is a block diagram of a recruitment enhancement system including a developer database interacting with two applicant tracking systems in accordance with an embodiment of the present invention.

FIGS. 4A and 4B are examples of information communicated between a recruitment enhancement system and an applicant tracking system in accordance with an embodiment of the present invention.

FIG. 5 illustrates a method of gathering and aggregating information for an individual in accordance with an embodiment of the present invention.

FIG. 6 is a flow chart of a method of filtering user data for protected class information in accordance with an embodiment of the present invention.

FIG. 7 is a flow chart of a method of filtering user data for protected class information including training a filter in accordance with an embodiment of the present invention.

FIGS. 8A and 8B shows an example of an interface configured to display information that can be gathered and aggregated by the system for an individual and then filtered in accordance with an embodiment of the present invention.

### DETAILED DESCRIPTION

In the following paper, numerous specific details are set forth to provide a thorough understanding of the concepts underlying the described embodiments. It will be apparent, however, to one skilled in the art, that the described embodiments may be practiced without some or all of these specific details. In other instances, well known process steps have not been described in detail in order to avoid unnecessarily obscuring the underlying concepts.

As will be described in more detail as follows, a recruitment enhancement system for electronic job recruiting system is described. The recruitment enhancement system is configured to gather and analyze information about potential employees. For example, the system can be configured to gather information about individuals from publically available sources, such as a social media sites. The aggregated individual information can be made available to users of the recruitment enhancement system.

To prevent use of the aggregated individual information in a manner that is considered illegal for recruiting purposes, the aggregated individual information can be filtered before being output by the system. For example, the aggregated individual information can be filtered for protected class information, such as race, gender, age, etc., before it is presented to a user. Filtering the information in this manner may prevent someone from eliminating someone for a job position in an illegal manner or asking inappropriate questions that could indicate discriminatory intent. In one embodiment, a Bayesian type data filter that is trained to recognize protected class information can be employed.

One objective of the analyzing the aggregated individual information is to identify job applicants most likely to successfully perform jobs associated with available job positions. For example, a job applicant's proficiency or knowledge pertaining to a particular aspect of a job can be assessed and scored, such as their knowledge or proficiency of a particular programming language for a programming job. The scoring can be used to rank applicants which can be used to screen or filter job applications.

The information derived from the analyses, such as the scores, can be referred to as job suitability parameters. The job suitability parameters can be designed to aid job recruiters during the manual selection process of job applicants. If desired, the job suitability parameters can be used in conjunction with the filtered aggregated individual information to make recruiting decisions. The recruitment enhancement system can be configured to generate an interface that allows job recruiters to view the job suitability parameters and filtered aggregated individual information for various candidates. There are various local and national laws and regulations that govern recruiting decisions including what information can be used to the make the decisions. Thus, the system can be configured to use various techniques that attempt to identify and present only information that is allowable according to these laws and regulations.

With respect to the following figures, details of a recruitment enhancement system that includes one or more databases of information about skilled individuals and recruiting services provided by the system using these databases are described. One type of information that can be stored to the databases can be self-generated information, such as blog posts or tweets, made by the individuals and submitted to publically accessible web-sites. As another example, this type of information can be electronically submitted in a resume when the individual applies for a job. An interface can be provided with the system that allows the self-generated information to be accessed by job recruiters for the purposes of making recruiting decisions. The system can be configured to apply one or more filters to the information before it is presented to the job recruiters. In one embodiment, the system can be configured to identify and remove information that may possibly contravene recruiting laws and regulations.

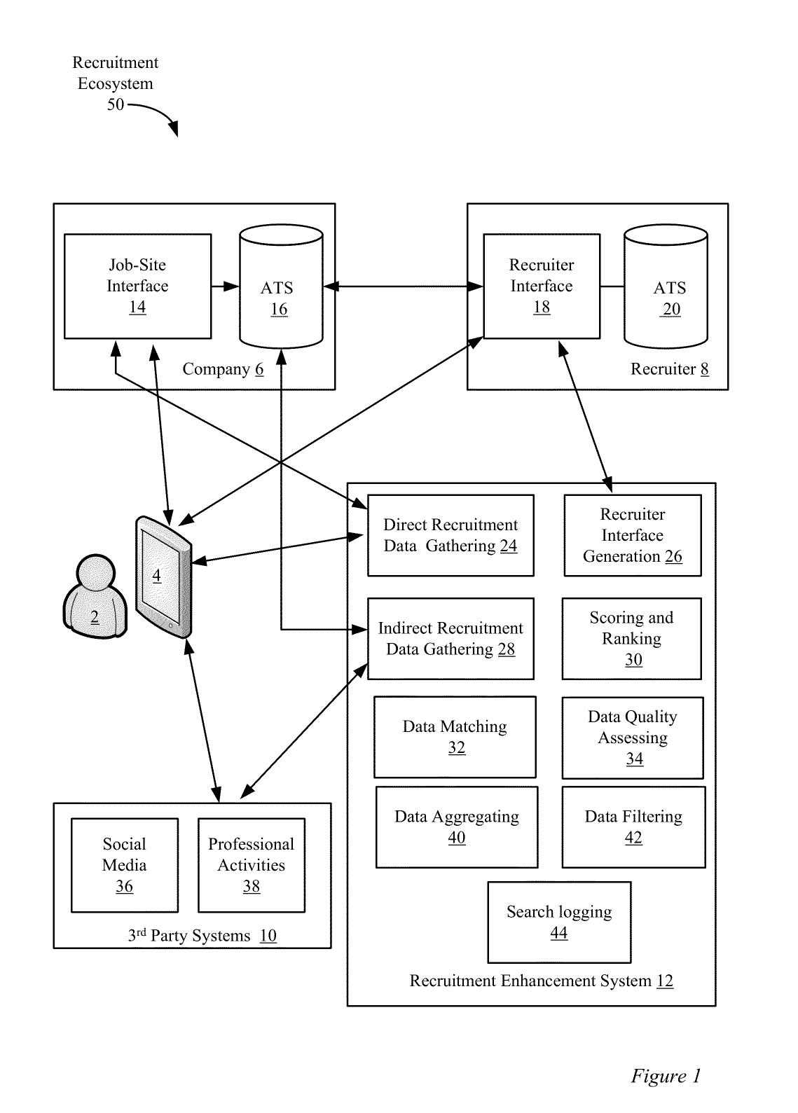

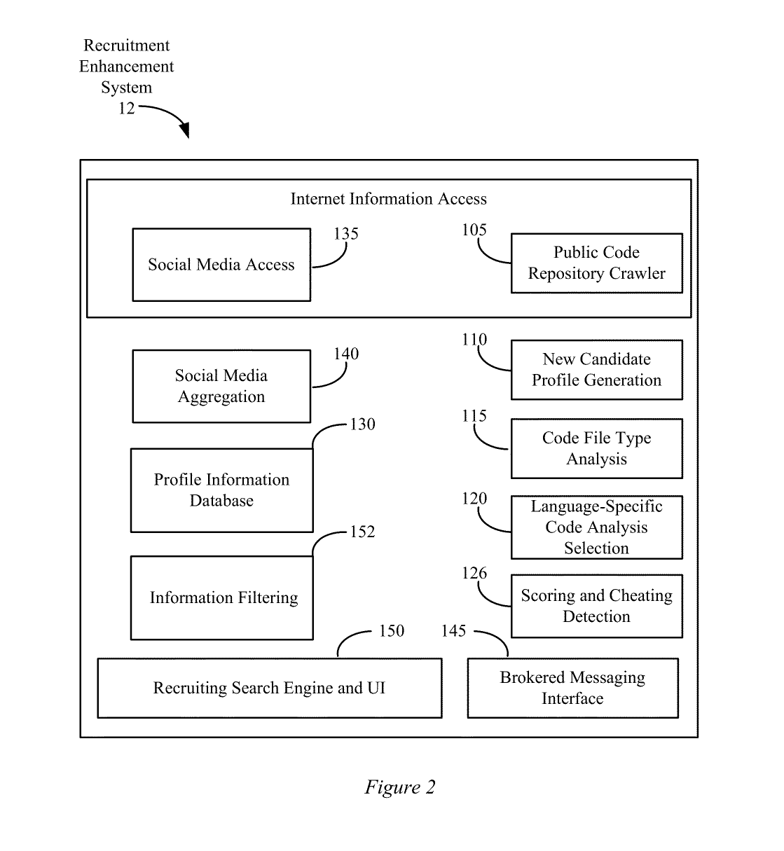

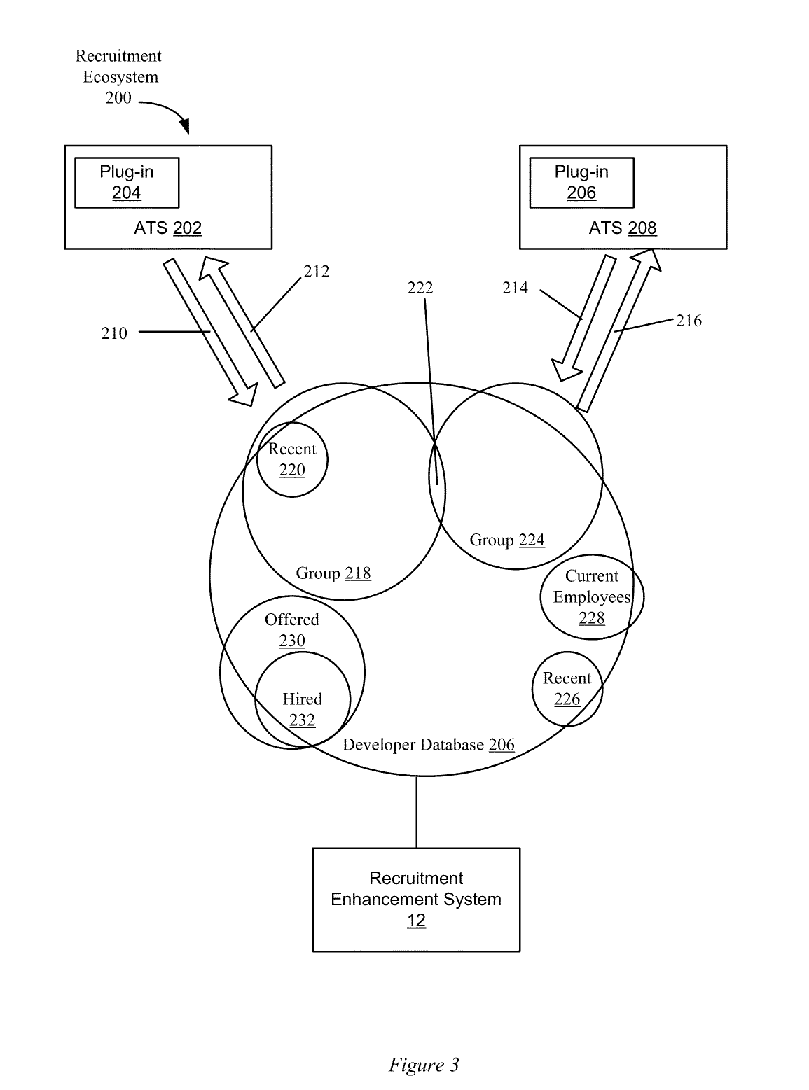

In particular, with respect to FIG. 1, a recruitment ecosystem is described. Within the recruitment ecosystem, interactions involving individuals seeking jobs, recruiters seeking candidates, companies providing jobs and a recruitment enhancement system are discussed. With respect to FIG. 2, a recruitment enhancement system is described. In particular, methods and apparatus for formulating a proprietary database of information relating to skilled individuals are discussed. With respect to FIG. 3, 4A, 4B, methods and apparatus for recruiting services that leverage the proprietary databases maintained within the recruitment enhancement system are discussed. The recruiting services can involve receiving a list of individuals from a recruiter and attempt to match individuals from the list to individuals stored in the proprietary databases. Reports can be generated for matched individuals on the recruiters list and returned to the recruiter. The recruiter can use information in the report to further their recruiting activities.

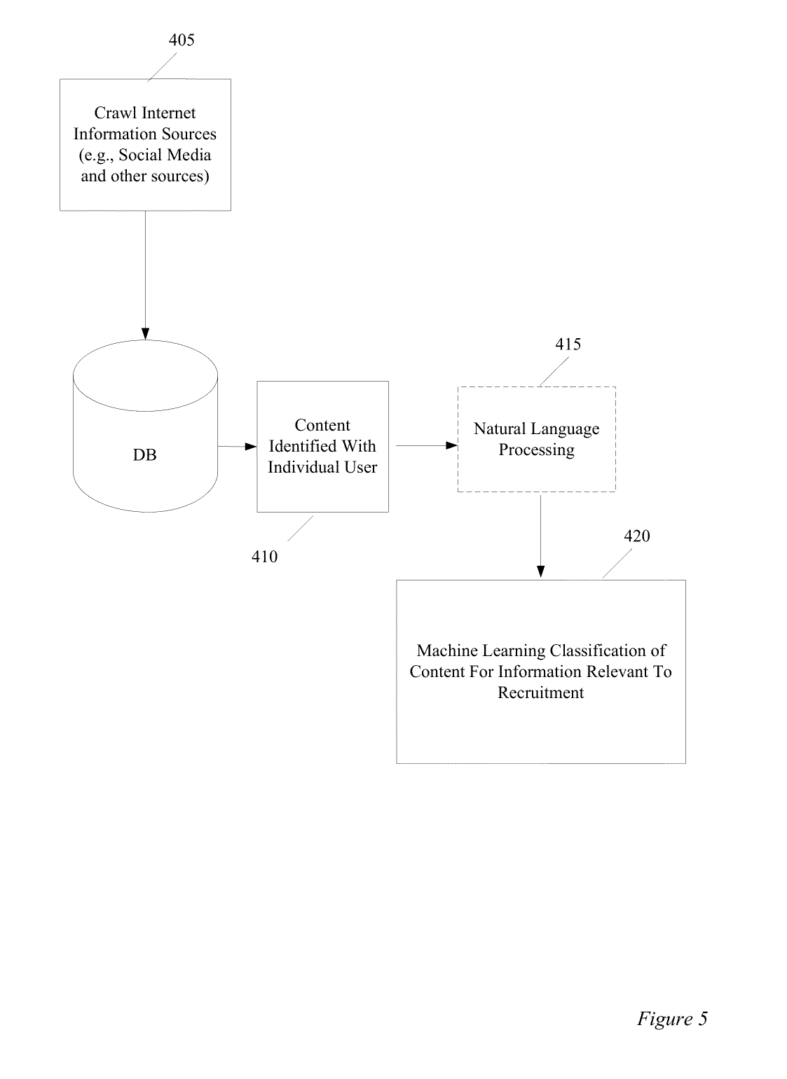

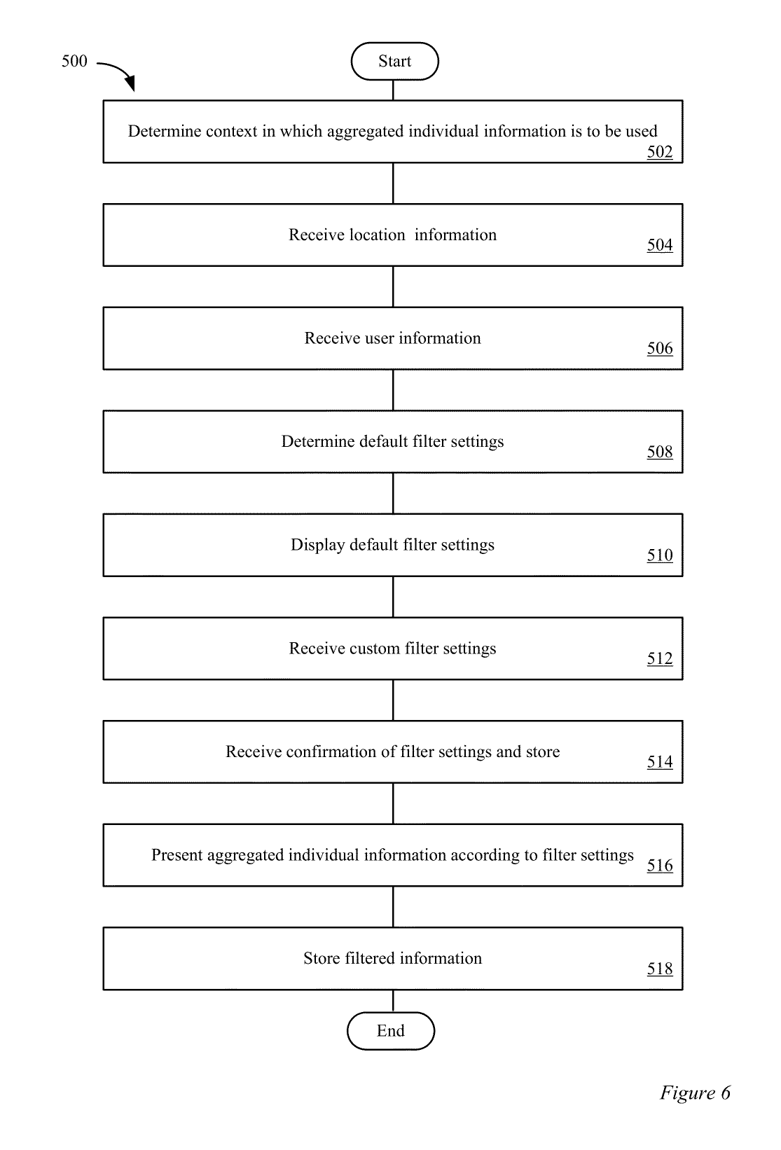

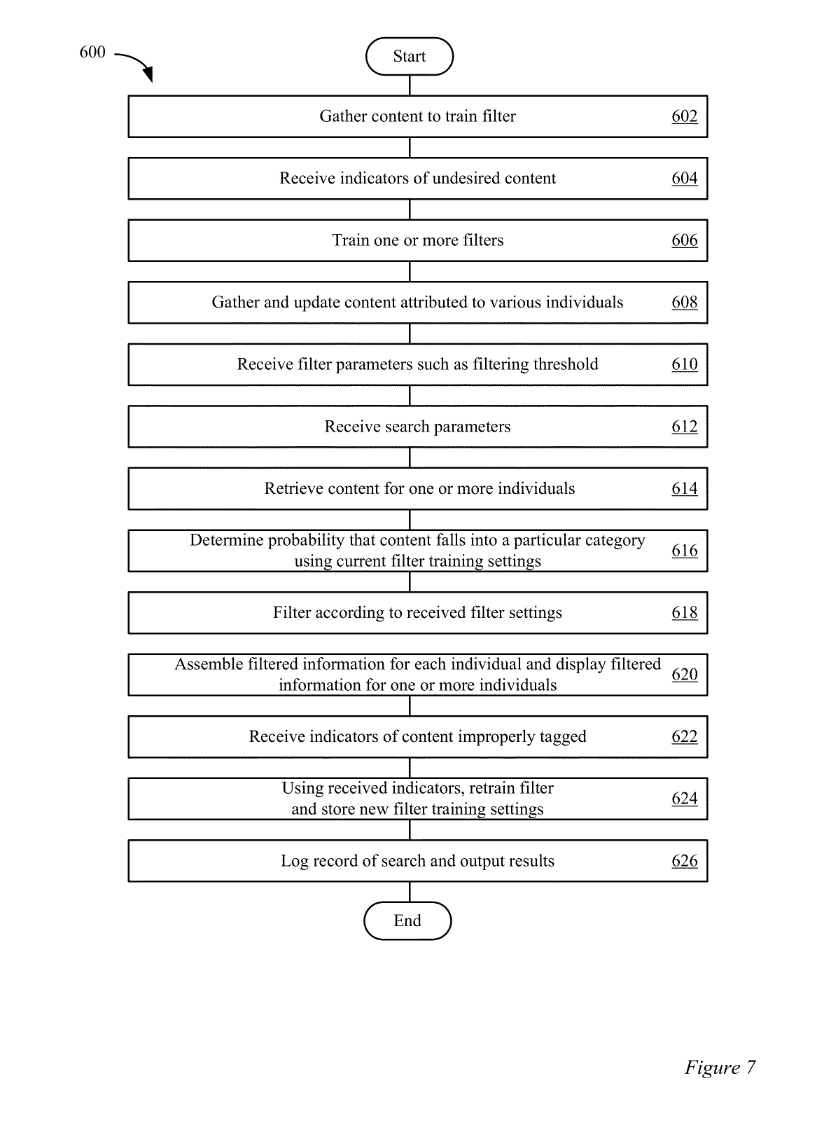

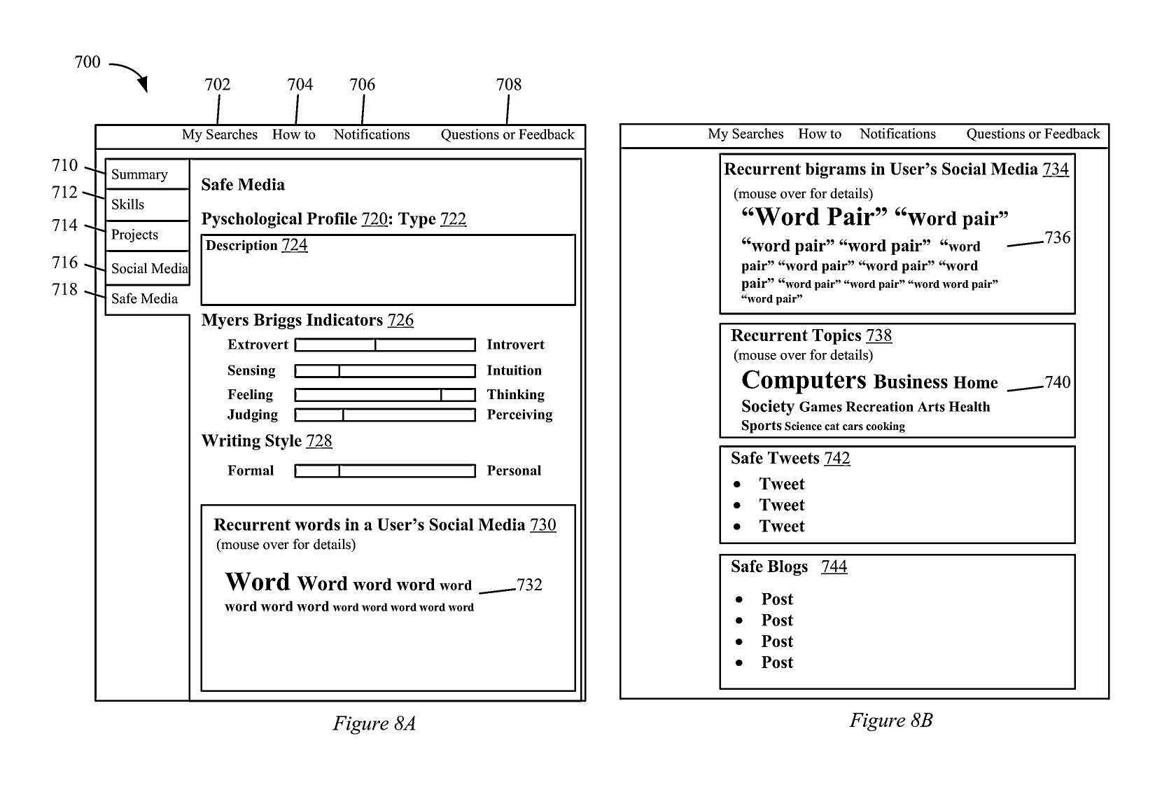

With respect to FIG. 5, a method of obtaining and aggregating publically available information about individuals, such as information available from social media sites, is described. With respect to FIG. 6, methods are described for filtering the aggregated individual information obtained using the method of FIG. 5. In one embodiment, the filtering can involve identifying and removing protected class information to prevent it from being used in a manner that could be inferred to be discriminatory. With respect to FIG. 7, methods for initializing and maintaining data filters are discussed. In a particular embodiment, a Bayesian type filter can be trained to estimate a probability of whether a particular unit of data is protected class information. Finally, with respect to FIGS. 8A and 8B, an example of individual information that has been gathered, aggregated and then filtered by the system is described.

Recruiting Ecosystem Including Recruitment Enhancement System

In this section a recruiting ecosystem including a recruitment enhancement system is described. In a recruiting ecosystem, individuals can engage with various electronic systems to supply information that allows them to apply for existing jobs, or to be considered for future jobs when positions open up. In response to the supplied information, recruiters can select from among the individuals and attempt to initiate additional job recruiting related interactions. For instance, based upon the received data, a job recruiter can identify an individual and attempt to contact the person to set up an interview.

A job prospect can be a person that is interested in working for a company and has agreed to provide information, but may not have applied for a particular job. A job applicant can be a person that has applied for a job, and agreed to provide information as part of the application process. As described herein, a recruitment enhancement system 12 can be provided, that can be used to gather information, and engage job candidates and job applicants alike.

In the recruitment enhancement system, methods and apparatus can be provided for gathering secondary recruitment data that is beyond the resume and other application data that is usually gathered in the job application process, via applicant tracking systems. The secondary recruitment data can be analyzed and scored. Based upon the score, one or more rankings for a job candidate can be generated. In one embodiment, the secondary recruitment data and rankings can be stored in a proprietary database maintained at the recruitment enhancement system.

As an example of ranking or scoring, an individual in the recruitment enhancement system 12 can be ranked independent of, or relative to, a group of other job candidates or job applicants, such as a group of job applicants applying for the same job, or a group of job candidates within the same profession. An independent rank can involve comparing the individual's performance to some derived scale. A relative rank can involve comparing the individual's performance to other individuals within a group.

In addition, the recruitment enhancement system can provide an interface for presenting secondary recruitment data. One example of secondary recruitment data may be self-generated information, such as blog posts, tweets, pictures, or profile data, generated and posted to publically accessible sources, such as web-sites. In addition, a job candidate may submit secondary recruitment data as part of a job application process, such as when the job candidate electronically submits a resume as part of an Internet-based application process. The recruitment enhancement system can be configured to gather the secondary recruitment data, aggregate it and generate an interface that allows the aggregated information to be viewed by a recruiter.

In one embodiment, the system can apply a number of different types of filters to the secondary recruitment data before it is presented to a job recruiter. One type of filter may be configured to identify and remove before it is presented, individual information that could be used to make an “illegal” recruiting decision. As described above and as will be described in more detail with respect to FIGS. 6, 7, 8 and 9, one type of filter can be configured to detect and remove protected class information.

In one scenario, as will be described in more detail with respect to FIGS. 3, 4A, 4B and 5, a company can send information related to a group of individuals that have recently applied for job, have applied for a job in the past, or have provided information indicating their interest in working for the company. The information associated with these individuals can be stored in a company ATS (applicant tracking system). Upon receiving the information, the recruitment enhancement system can be configured to rank the group of individuals one or more different ways. For instance, individuals recently applying for jobs can be compared against individuals that have been hired by the company. In another example, the group of individuals can be compared against a group of individuals stored in a proprietary database associated with the recruitment enhancement system.

As described above, the recruitment enhancement system can be configured to receive information from the company ATS. During a job application process, a job candidate may submit information, such as protected class information, which a recruiter may not wish to view because of legal liability reasons associated with complying with hiring laws and regulations. This information may be stored in the company's ATS. In one embodiment, after receiving the information the system can be configured to apply one or more filters to the information, aggregate it with information gathered by the recruitment enhancement system and then present it to the job recruiter. Thus, the company's ATS information and the information gathered by the recruitment enhancement system can be filtered in a consistent manner.

The recruitment enhancement system 12 can be configured to generate an interface that allows an outside entity, such as a job recruiter, to access the ranking data and/or the filtered secondary recruitment data about candidates. The outside entity can use the ranking data and secondary recruitment data as a basis for additional investigations, such as learning more about particular individuals, and determining whether to contact particular individuals for additional interactions, such as a job interview. In one embodiment, as described in more detail with respect to FIG. 3, the interface can be provided as a part of a plug-in application for their ATS.

In particular embodiments, the recruitment enhancement system 12 can be tailored to particular professions. For example, the recruitment enhancement system 12 can be tailored towards the computer programming profession, where the system is configured to gather secondary recruitment data that allows computer programming professionals to be ranked according to some scale, and/or relative to other computer programming professionals that have participated in a common recruitment enhancement activity. A recruitment enhancement system associated with program developers is described below in more detail with respect to FIG. 2. In another example, the recruitment enhancement system 12 can be tailored towards medical professionals, such as doctors or nurses, where the system is configured to gather secondary recruitment data that allows the doctors or nurses to be ranked.

FIG. 1 is a block diagram of a recruitment ecosystem 50 including a recruitment enhancement system 12 in accordance with the described embodiments. The ecosystem 50 includes company systems, such as 6, recruiter systems, such as 8, a recruitment enhancement system, such as 12, and 3^{rd} party systems where individuals can engage in various activities, such as 10. Social media sites are one example of 3^{rd} party systems. An individual 2, who may or may not be currently engaged in the job hunting process may interact at various times with each of the systems via a computational device, such as the tablet device 4. Typically, the interactions may involve establishing communications between the computational device and one or more remote servers associated with each of the systems over a local and/or wide area network. For instance, the tablet device 4 can be used to establish communications and interact with a server associated with a social media site.

Communication devices typically include a processor, a memory, networking capabilities, and a user interface that allows for the input and output of data. Examples of communication devices that can be utilized include, but are not limited to, smartphones, laptop computers, netbook computers, desktop computers and tablet computers. Interface devices that can be utilized include a display, a keyboard, and a microphone in combination with speech recognition, a mouse, a touchpad and a touchscreen.

The recruitment enhancement system 12 can include components for a) direct gathering of recruitment data 24, b) generating a recruiter interface 26, c) indirect gathering of recruitment data 28, d) scoring and ranking 30, e) data matching 32, f) data quality assessing 34, g) data aggregating 40, h) data filtering 42 and i) search logging 44. The system 12 can be hosted on one or more servers including processors, memory and network interfaces. Direct recruitment data gathering 24 can involve generating one or more activities in which an individual can directly participate, such as a knowledge-based test, a game, a puzzle or solving a problem. The direct recruitment data gathering can be used to identify and engage individuals that have interest in a company, or encourage individuals to be interested in a company. In addition, the direct recruitment data gathering can be used to possibly assess potential job candidates.

In general, the capturing of data from an individual directly engaging in an activity can be part of direct recruitment data gathering. For instance, an individual engaging in an activity, such as an interview, can be captured on video data as part of direct recruitment data gathering 24. In another example, when an individual takes a test, information such as their answers, how long they take to answer each question, and their total time can be gathered and analyzed.

The indirect recruitment data gathering can involve gathering information from an individual's on-line activities, such as participation in social media sites 36, professional sites 38 or even sites related to a user's hobbies. The person's on-line activities can be hosted on 3^{rd} party systems 10, such as a social media site. In one embodiment, when a user agrees to participate in an activity involving direct recruitment data gathering, a user may agree to provide access to their on-line activity information which can be captured by component 28. For example, a user can provide access to their Facebook™ or Linkedin™ profile for a chance to participate in a knowledge-based test related to recruiting. The knowledge-based test can be referred to a recruitment enhancement activity. After access is granted, the indirect recruitment data gathering component 28 can retrieve information about their on-line activities from the 3^{rd} party systems.

The information gathered by components 24 and 28 can be stored and analyzed. Then, job suitability parameters can be derived. For example, the scoring and ranking components 30 can be used to score information directly gathered during an online test and then rank individuals based upon the scores. In addition, information about an individual's online activities can be gathered indirectly from various third-party systems 10, and job suitability parameters can be derived from this information. For example, based upon software code that a user has posted to a professional site, the individual's coding ability can be scored and ranked. The software code may be executable. However, the software code doesn't have to be executable to generate a score or a ranking. Methods related to scoring code are described below with respect to FIG. 2.

In particular embodiments, scores and ranks can be derived from data that is gathered directly and/or indirectly. For example, as will be described below, a score and/or a rank can be generated based upon an individual's participation in a knowledge-based test. In another example, a score and a rank can be generated based upon an individual's participation in a knowledge based test, and information retrieved from a third-party site, such as social media site. Again, a person can be ranked relative to a group of other individuals, such as a group of individuals participating in a common task, or according to some derived scale or measure.

The data matching component 32 can be used to match various data sets to a particular individual. For example, an individual may use multiple names in their on-line activities. As another example, different individuals can share a common name. The data matching component 32 may use information verified from one source to validate another information source. For example, if an individual grants access to their Facebook™ profile and then another source of information is available, such as their profile in a professional organization or data that they have supplied in applying for a job, the information from the two sources can be compared by component 32 to see if they are the same person. When the comparison indicates they are the same person, a portion of the information from the multiple sources can be stored at the system 12 or at least the links to the multiple sources can be stored. This information can be made available in a recruiter interface.

The data quality assessing component 34 can be used to assess a validity of gathered data. For example, the component 34 might be used to determine whether someone has cheated on a knowledge-based test administered by system 12 or tried to game the system 12 in some other manner. As another example, the component 34 might be used to determine whether a person has falsified data they have provided as part of a job application. Information that is identified as invalid may be flagged. In addition, the system 12 can be configured not to use information identified as possibly invalid for scoring and ranking purposes.

The data aggregating component 40 can be used to aggregate information received from a number of different sources, such as via the direct recruitment data gathering 24 and the indirect recruitment data gathering components 28. As described above and in more detail with respect to FIG. 3, information can be obtained from crawling or scraping publically available web-sites or from a direct download from an ATS. Before the aggregated data for an individual is presented via the recruiter interface 26, the data filtering 42 can be applied.

The data filtering 42 can be used to identify certain types of data that may be of interest to a user of the system. The types of data of interest can be provided as search parameters input by the user. The identified information that satisfies the search parameters can then be output via the interface 26. In one embodiment, the data filtering 42 can be configured identify certain types of information that are to be blocked from output by the system. For example, in one embodiment, a filter can be provided which removes protected class information from the aggregated data. Then, a set of data filtered for this information can be output via the interface 26.

In particular embodiments, the system can be configured to filter externally provided information. For example, a recruiter wishing to view information in their company ATS can submit the information to the recruitment enhancement system. The system 12 can apply one or more filters, such as a filter to remove protected class information, and then return the filtered information to the ATS. The ATS can then store and/or output the filter information to the recruiter according to an interface provided by the ATS. The information received from the ATS may or may not be added to databases maintained by the recruitment enhancement system.

As another example, a recruiter can execute a search locally on their ATS and the ATS can return a set of information. Prior to outputting the information, the ATS can establish communications with the recruitment enhancement system and invoke one or more filters available at system 12. The information to be filtered can be sent to system 12. After the information is filtered by system 12, it can be returned to the ATS, such as 16 or 20. Then, the filtered information can be output via local interfaces, such as 14 or 18.

The search logging 44 can be used to keep records of searches performed at the system 12. For instance, when a search is performed, the system can store a record of when the search was performed, who performed the search, information related to search parameters and filters applied to the information and some details related to information returned in the search. For example, names and/or pictures of individuals identified by a search can be stored. In some instances, the search logs can be stored for years.

The recruiter interface 26 can allow recruiters to directly access some portion of the information available at system 12. In another embodiment, as described in more detail with respect to FIG. 3, a recruiter can access the system 12 via a plug-in module coupled to their ATS, such as 16 or 20. As described above, the information can be filtered before it is output via the recruiter interface 26. For example, via the interface, recruiters may be able to access scores and ranks about various individuals. Further, via the interface a recruiter may be able to search for individuals with particular skills and assess their job suitability parameters, such as scores and ranking. In addition, via the interface, the recruiter may be able to view secondary data that is available for individuals identified in the search. The secondary data can be filtered so that only certain types of information are output, such as education details. After initial filtering, a second filtering operation can be instantiated to identify and remove certain types of information, such as protected class information (e.g., age related information).

The company 6 and the recruiter 8 can each maintain applicant tracking systems, such as 16 and 20. If a recruiter 8 works for the company 6, then the recruiter 8 may not maintain a separate applicant tracking system. The recruiter 8 may have access to an interface or interfaces that allows them to interact with the recruitment enhancement system 12, an individual 2 via their device 4 or some other mechanism, their own application tracking system 20 and a company application tracking system 16.

The company 6 can sponsor a job-site interface 16. Via the job site interface 14, an individual, such as 2, may be able to learn about different jobs and optional apply for jobs. The job application process can include uploading a resume. Subsequently, the information in the resume can be filtered via system 12. Information from the job application process can be stored to the company application tracking system 16. In particular embodiments, the company 6 may allow recruiters, such as 8, and/or the recruitment enhancement system to access the application tracking system 16.

In one embodiment, one or more direct recruitment data gathering activities can be triggered from the job-site interface 14. For example, when a user applies for a particular job, such as after submitting their information or a part of submitting their information, a link can be established from the job-site interface 14 to the recruitment enhancement system 12. The recruitment enhance system 12 can then generate a recruitment enhancement activity that is used to directly gathered recruitment data. For example, as part of the recruitment enhancement activity an individual may be asked to take a knowledge-based test, play a game, solve a puzzle, solve a problem or combinations thereof.

Information captured from the recruitment enhancement activity can be scored or ranked and made available to recruiters via the interface generated by the recruiter interface generation component 26. An individual can participate in a number of different recruitment activities. Thus, the interface may allow a recruiter to view descriptions of the recruitment enhancement activities in which an individual has participated and jobs suitability parameters derived from their performance.

In one embodiment, via the interface, a recruiter may be able to send a request to an individual to participate in a particular recruitment enhancement activity. For instance, the recruiter may be interested in an individual for a particular job position. Via the interface, the recruiter can send a message to the individual indicating their interest in the person and requesting them to participate in a recruitment enhancement activity, such as taking a knowledge-based test associated with the job position. The message received by the individual can include information, such as a link to a web-site, which allows the individual to engage in the recruitment enhancement activity.

In one embodiment, the recruitment activity that is selected can be related to information associated with an available job. For example, a knowledge-based test can be implemented that is related to a skill needed for the job position. Their answers can be scored and the person can be ranked relative to other job applicants that have taken the test.

In other embodiment, the recruitment enhancement activity that is selected can be related to information supplied by the individual applying for the job. Via interface 14, an individual can submit information indicating that they possess a particular skill at a particular skill level, such as a number of years of experience in the skill For instance, the interface can ask the person to indicate how many years of experience the person has with the skill or the person can submit a resume including this information.

Based upon information supplied by the individual, the system 12 can be configured to select a recruitment enhancement activity that in some way measures or is predictive of the person having the claimed skill For example, an individual can be asked to take a knowledge-based test associated with their claimed skill Harder or easier test can be implemented depending upon the person's claimed skill level. The test answers can be received by the system 12, scored and analyzed. The scores and analyses can be used to assess individuals in regards to their proficiency in the claimed skill In addition, the individual can be ranked relative to other individuals with the same claimed skill level or according to a scale constructed for individuals of the claimed skill level. The system 12 can be configured to make information about an individual's score or rank in the recruitment enhancement activity available to recruiters.

Recruitment Enhancement System

FIG. 2 illustrates in more detail a functional block diagram of a recruitment enhancement system 12 in accordance with an embodiment of the present invention. The recruitment enhancement system may reside on one or more servers with associated processors and memory, wherein the computer code is stored on a computer readable memory. A database memory may be provided to store information for the recruiting service, including candidate profile information.

In the example below, the generation of a database, which may be a proprietary database, is described. The database is focused on individuals that are software developers. The use of software developers is provided for the purposes of illustration only and databases associated with individuals in other skilled professions can also be generated and maintained at the recruitment enhancement system.

For programmers, a crawler 105 is provided to crawl code repositories. For example, the crawler may use an API for code hosting sites such as GitHub. A new candidate profile generation module 110 determines whether the crawler has identified a new developer. If so, a profile ID is generated to build a new profile. A code file type analysis module 115 determined the file type of files being crawled. After the file type has been determined, the language-specific code analysis module is selected by module 120. Scoring and cheating detection is then performed by module 125.

Profiles are stored in a profile information database 130. A social media access module 135 provides access to social media information sites and a social media aggregation module 140 correlates aggregated social media information for individual profiles. In one embodiment, the social media information can include posts generated by an individual. For example, posts to their social media account, posts to a blog and/or tweets to their twitter account. The system can be configured to gather information using API's associated with various sites or via scraping information from the sites. Scraping involves extracting information from displayed web-pages. The scraping could involve optical character recognition and/or parsing of underlying mark-up language for information.

In one embodiment, the system can attempt to obtain a similar amount of information for each individual. For example, one hundred tweets or one hundred blog or status updates can be obtained for each person. As another example, the system can attempt to obtain up to one some number of words, such as one thousand words of content for each individual.

The system can be configured to regularly search for new content generated by an individual and update the content stored at the system 12. In one embodiment, when a content limit is reached, the system can be configured to remove old content when new content is added to maintain a content limit. For example, the system can be configured to store ten tweets for each individual. When the limit is reached and the system wants to add an additional tweet (e.g., the eleventh tweet), the system can be configured to remove add the most recent tweet and then remove the oldest tweet from the database. This updating method where older content is removed to make room for newer content can be applied to other types of content, such as blog posts.

The information filtering 152 can be used to identify and optionally block from output certain types of information. For example, as described above, the information filtering 152 can be used to identify protected class information previously gathered by the system 12. Then, the system can block this information from being output. In one embodiment, the information filtering 152 can be applied before information is even uploaded to the system. For example, the web crawlers or social media access modules may locate a unit of information associated with individual, such as a blog post or tweet. Next, the unit of information can be processed by the information filtering module. If the unit of information includes some content deemed unsuitable for viewing, such as protected class related information, then the system may not even upload the information. In other embodiments, the system can be configured to upload but tag the information so that it is only viewable in certain circumstances. In yet other embodiments, the information filtering 152 may not be applied during the upload process but may be applied when the information is retrieved by the system and prior to output by the system.

A messaging interface 145 is included in one embodiment as a mechanism for recruiters to contact individual developers. However it will be understood the messaging interface 145 may be omitted in some implementations. The messaging may, for example, be brokered in the sense of cloaking the user information and email address of the recruiter during initial attempts to contact a developer. A recruiting search engine and graphical user interface (GUI) module 150 is responsible for generating the graphical user interface that is provided for display on a user's computer. In one embodiment, the recruiter's search engine and GUI module can be configured to interact with a plug-in module that is provided to the recruiter's ATS (e.g., see FIG. 3).

The new candidate profile generation module 110 utilizes author information from crawled sites to detect that there is a new developer to be added to the system. Code repository sites include author information for each project. This author information is searched by the crawler. Each individual person with a profile has a unique ID. The unique ID is created the first time an individual programmer's name is discovered in crawling author information in code hosting sites. For example, when the crawler finds the names of people that have contributed code to a code hosting site, the system compares the unique ID from the network that the person is found on to the unique IDs in the database of the recruiting service for that network. If an ID doesn't exist, a new user ID is created.

The social media access module 135 and the social media aggregation module 140 provide a comprehensive set of social media links for each profile. The author information obtained from public repository sites such as GitHub and Stack Overflow may be incomplete or contain inaccuracies. However typically the author information will include at least an email address and perhaps also a name. This information can then be used to obtain additional social media information using commercial services such as Full Contact, Inc. of Denver, Colo., Fliptop, Inc. of San Francisco, Calif. and Rap Leaf of San Francisco, Calif. Many commercial services check by unique information, like email address, or a hash of the email address (a hash is a unique number generated by an email address. That way, companies can match users by email addresses, but protect their privacy by looking at hash numbers). In one embodiment a search of social media sites is performed of all of the sites listed under Full Contact's set of Social Network Types. From this information profile information identifying the names of developers may be generated along with associated information. For example, work history may also be scraped from social networking sites.

Direct scanning of social media sites is also an option, such as the option of scanning sites such as LinkedIn and Google Plus. However, there's usually not a one-to-one results process. For example, if a developer has a common name, such as “John Smith,” a scan based on their name may turn up more than one hit. To find additional social media links for a particular profile it is thus desirable to look for multiple matching factors (location, title, company, name, etc.), and then calculate the probability that it's a match. If the probability is higher than a certain number, the system automatically merges the profiles. If the probability is less than that threshold, the system sends a notification that there needs to be a manual review process.

In one embodiment, an individual may have granted the recruitment enhancement system access to one of their profiles at a social media site. For example, to participate in contest, which is an example of a recruitment enhancement activity described with respect to FIG. 1, the individual may have given the recruitment enhancement system permission to access their profile at Linkedin™. When permission is granted in this way, the recruitment enhancement system may be able to access more information about the individual than when social media sites are directly scanned. Once links to social media are identified for a developer they can be refreshed at a rate slower than other information in the public code repositories. Individuals typically add new social networks infrequently and the URLs of social media sites are generally static.

Recruiting Services Using a Recruitment Enhancement System

In this section, recruitment services that leverage information gathered and analyzed at the recruitment enhancement system are described. One service that can be provided is identifying and optionally filtering certain types of information. For example, the system can be configured to identify protected class information and filter it out before it is viewed by a recruiter or another person involved in a hiring decision. Interfaces that allow outside entities to access these services are also described. For instance, an interface can be provided for an applicant tracking system that allows a recruiter to access recruitment services, such as candidate scoring, from a recruitment enhancement system. As another example, an interface can be provided that allows a recruiter to upload data that can be filtered by the system, such as filtering out protected class information.

FIG. 3 is a block diagram of recruitment ecosystem 200. The recruitment ecosystem 200 includes two applicant tracking systems (ATSs), 202 and 208 and a recruitment enhancement system 12 including a developer database 206. The developer database 206 includes information about software developers. This example is provided for the purposes of illustration only as the recruitment ecosystem 200 can include a plurality of different applicant tracking systems. In addition, as is described in more detail below, the recruitment enhancement system 12 can be configured to provide access interfaces that don't require an ATS. Further, database 206 can include information about individuals from other professions other than software developers and/or separate databases (not shown) can be maintained for individuals in other professions.

The applicant tracking systems, 202 and 208, can include data associated with a plurality of individuals that have applied for jobs over some period of time. In applying for a job, each individual may have supplied information that is stored to an ATS. For example, an individual may have electronic uploaded a resume in some format. After the resume is uploaded, the resume may be processed. For example, optical character recognition can be applied to a scanned in image of the resume.

After processing, information from the resume can be parsed and stored to an ATS database. The format of the database including the record structure and the information stored in the database can vary from ATS system to ATS system. For example, ATS 202 can store a first set of applicant information in a first order and ATS 208 can store a second set of applicant information in a second order.

As another example, the ATSs may also include information about individuals that have expressed interest in the company through some mechanism, such as a social media application. For example, via a social media application a user may have requested interest in a company and supplied a name and e-mail to receive some type of information. As another example, via a social media application, a user may have provided a social media profile to participate in a company related activity. Information obtained via a mechanism, such as a social media application, can be stored to the ATS. Thus, in general, there are many different scenarios in which information can be gathered about an individual and then entered into an ATS and information obtained via the job application process is only one example in which information about an individual can be provided to an ATS.

The ATSs can be associated with different entities. For example, ATS 202 can be associated with a first company where it includes information for applicants that have applied for jobs at the first company and ATS 202 can be associated with a second company where it includes information for applicants that have applied for jobs at the second company. As another example, ATS 202 can be associated with a first recruiter that has performed recruitment searches for a first group of companies and ATS 208 can be associated with a second recruiter that has performed recruitment searches for a second group of companies different from the first group. Thus, individuals in one ATS may have applied for jobs at different companies serviced by a recruiter or group of recruiters.

In some instances, information stored in each of the ATSs can overlap. For instance, when ATS 202 and ATS 208 are associated with companies in the same field, it is possible that the same individual has applied for jobs at each of the companies. Thus, ATS 202 and ATS 208 can include information, such as resume information associated with the same individual. However, because companies and recruiters usually closely guard the information stored in their ATS and don't generally share the information, neither of the entities controlling ATS 202 or ATS 208 is likely to know about the overlaps between their ATS databases.

Using an ATS database, such as 202 and 208, a recruiter can perform searches over the records in the ATS database. A search can allow a recruiter to identify a group of records that satisfy particular search criteria. For example, if the database stores information related to an individual's experience level with a particular programming language, then a recruiter can perform a search for candidates satisfying the experience level requirements for a particular job. The outcome of the search can be a list of candidates meeting the search criteria and information about each candidate.

After searching, a recruiter can choose to contact various individuals for additional scrutiny, such as interviews. The recruiter may continue to contact individuals represented in the ATS until a job position is filled. After the job position is filled, the information about individuals that were not hired may still remain in the ATS. Thus, search results can include information about job applicants that have applied for a particular job opening, information about individuals that have previously applied for other jobs and individuals that have been entered into the ATS through other mechanisms, such as via a social media application.

In particular embodiments, information about all or a portion of the candidates in an ATS can be sent to the recruitment enhancement system 12. As an example, in 210, information about one or more individuals stored in ATS 202 can be sent to recruitment enhancement system 12. As another example, in 214, information about one or more individuals stored in ATS 208 can be sent to the recruitment enhancement system 12.

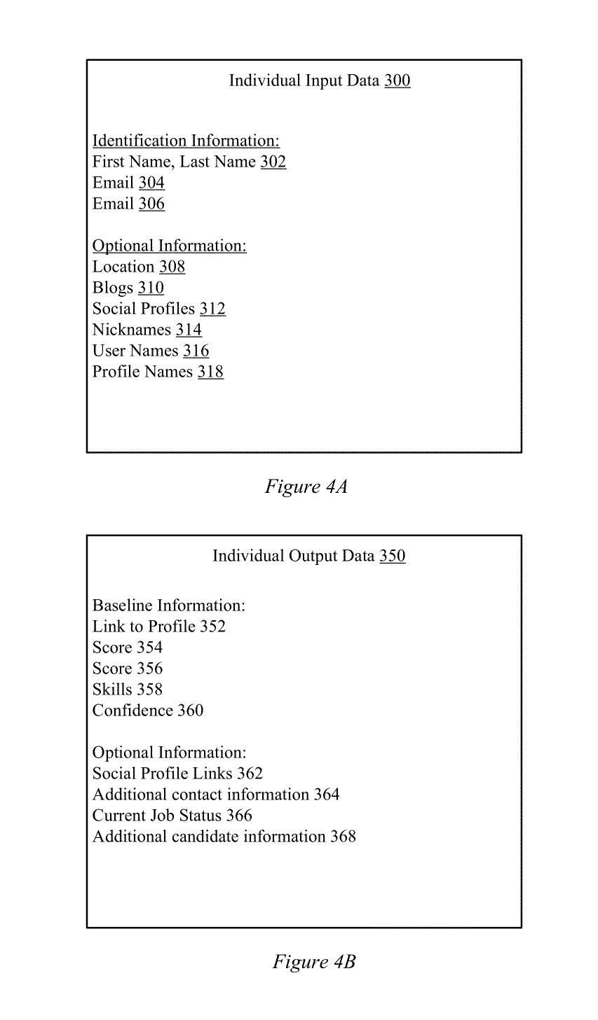

The information sent from the ATS to the recruitment enhancement system 12 can be used to provide a recruitment enhancement service. In various embodiments, as will be described in more detail below, one recruitment enhancement service can involve scoring or ranking individuals, such as software developers, which are identified from the information received from ATS in a recruitment service request. Another recruitment enhancement service can be to provide secondary recruitment data about an individual, such as information retrieved from publically available sources. Some examples of information that can be used to identify an individual that may be stored in an ATS and sent to system 12 are described with respect to FIG. 4A. Some examples of information that can be returned about an individual from system 12, such as but not limited to a score or a rank are described with respect to FIG. 4B.

Next, some of the information that can be sent to system 12 as part of a recruitment service request is described with respect to FIG. 4A. Then, additional details about FIG. 3 are described followed by a description of FIG. 4B. The individual in FIG. 4A can be one among group of individuals whose information is sent in 210 or 214. In a communication between an ATS and system 12, identification information about each individual, such as a first name and a last name 302, can be sent. In addition, one or more e-mail addresses, 304 and 306 can be sent that are believed to be associated with the identified individual. In one embodiment, the recruitment enhancement system requires a first name, last name and at least one e-mail address to provide a recruitment service involving assessing a skill level of the individual.

For competitive purposes and for privacy reasons, a company may not wish to release too much information about an individual. An individual name and e-mail address or addresses are likely to be publically available. Thus, an advantage of sending only a name and email addresses is it allows the company to maintain that it is protecting the privacy of individuals because only a limited amount of information is sent and what is sent is likely to be publically available.

Besides the name and the e-mail address or addresses, one or more additional types of information can be sent. The recruitment service may involve determining whether the recruitment enhancement system 12 has additional information about the named individual. Individuals can share names. Thus, the additional information may allow the system to confirm with a higher level of confidence that a named individual from an outside entity is properly identified by system 12.

Some example of additional information include but are not limited to location information 308, blog information 310, social profile information 312, nicknames 314, user names 316 and profile names. The location information 308 may be an address where the person lives or works. In one embodiment, the location information 308 may be a partial address, such as a city where the individual lives or works. The blog information 310 is example of information associated with an individual's on-line activities. For example, information 310 can be associated with a user's online blog, such as link (e.g., a URL) to the blog.

In another example, information 312 may be associated with an individual's on-line profile. For example, a link to a Linkedin™ profile or information obtained from the on-line profile can be sent. Multiple instances of information 312 can be sent. For instance, a first link to a first profile and a second link to a second profile can be sent. The system 12 can be configured to parse the received information when multiple instances of particular type of information or no instances of a particular type of information, such as 312, are received. In other examples, information, such as nicknames 314, usernames 316 or profile names 318, associated with a user's on-line activities can be provided to system 12. As will be described in more detail as follows, the received information can be used to determine whether the named individual also has a record in the developer database 206 maintained by the recruitment enhancement system 12. In general, any information available at the ATS that can help to locate information about the individual in the developer database 206 or other database maintained at the recruitment enhancement system can be sent.

The information that is sent can vary from individual to individual. For example, for a first individual, a name and one e-mail address can be sent. For a second individual, a name and two e-mail addresses can be sent. For a third individual, a name, one e-mail address and a link to a social profile. For a fourth individual, a name, two e-mail addresses and a number of different user names can be sent. Thus, the recruitment enhancement system 12 can be configured parse and utilize different combinations of information that vary from individual to individual.

In a particular embodiment, the recruitment system can be configured to receive information about an unnamed individual. For example, the first name and last name 302 may not be known. Based upon the received information, the system 12 can be configured to determine a possible name of the individual and return the information to the entity that sent the information about the unnamed individual.

The information described above doesn't necessarily have be stored in or sent from an ATS. In one embodiment, the received information is used to locate information about individuals in a database maintained by the recruitment enhancement system 12. For this purpose, it doesn't matter where the information resides before it sent as long as it is suitable for locating records of individuals maintained in the database or databases of system 12. Thus, the example of an ATS as a source of the information sent to the recruitment enhancement system is for the purposes of illustration only and is not meant to be limiting.

In one embodiment, besides information about the individuals, information about a job position for which candidates are desired can be sent. For example, a portion of a job description can be sent in a recruitment service request. In one embodiment, when the system 12 receives a job description and a list of a number of individuals, the system 12 can be configured to store information about the individual and information about the job position for which they are being considered to a database maintained at system 12.

Returning to FIG. 3, in one embodiment, a plug-in module, such as 204 and 206, can be provided for an ATS. The plug-in module can be configured to be compatible with the recruitment enhancement system 12. The plug-in modules can be configured to extract information from an associated ATS and send it to the recruitment enhancement system in format that is recognizable by system 12.

In one embodiment, the plug-in module may provide an export feature. For instance, an export button can be located within an interface provided with the search functions of the ATS. In response to a search, a selection of the export feature can cause an electronic data file to be generated that is compatible with the recruitment enhancement system 12. The electronic data file can include information consistent with the search, such as the names and e-mail addresses of the individuals identified in the search. As described above with respect to FIG. 4A, additional information related to a particular individual can also be included.

An API (Application Program Interface) can be provided with system 12. The API can describe formats and particular data types that system 12 can accept. The API can be used by third-party developers to construct a plug-in module for an ATS.

The extracted information can be sent to the recruitment enhancement system in 210 or 214. The information can be sent as part of a recruitment service request. The plug-in module may require a user to provide an additional input before the data is sent, such as a selection of a send button. In one embodiment, the plug-in module, such as 204 or 206, can be configured to establish electronic communications with the recruitment enhancement system 12 and then send data to the recruitment enhancement system 12 that has been extracted from an ATS. The data can be sent electronically via a secure connection between the ATS and the recruitment enhancement system 12. The information that allows the secure connection to be established may have already been exchanged by the systems.

In one embodiment, entities can be charged according to their utilization of the recruitment enhancement system 12. Thus, the data sent from the ATS, such as 202 or 208, can include identification and authorization information for an entity requesting a service. The authorization information can be used to determine whether the entity sending the data is authorized to obtain a requested service from the recruitment enhancement system 12. The identification information may allow the recruitment enhancement system to attribute its utilization to the entity and bill it for the services.

Although not shown, the recruitment enhancement system 12 can be configured to provide an interface, such as web-based interface, that allows an entity to upload information that is compatible for receiving a service from system 12, such as a file including a list of names and e-mail addresses to the system. The system 12 can be configured to process the file and generate a report. Upon payment, entity can receive the report. The report can be emailed to an address specified by the entity or a link can be provided that allows the entity to download the report. Thus, a plug-in module that provides an interface to an ATS may not be required.

After receiving the individual information in 210 and 214, the system 12 is configured to determine whether it has information about the received individual's in its developer database 206. Possible results of this determination are shown graphically in FIG. 3. The largest circle represents individuals in the developer database 206. Group 218 can include one or more individuals from ATS 202. It can be seen that a circle associated with group 218 partially lies within the large circle associated with 206 and partially outside of it. The portion inside the circle represents individuals in group 218 that can be matched to individuals in the developer database 216. The portion outside the circle 206 represents the portion of individuals that can't be matched to individuals within the developer database 206 with an acceptable degree of confidence.

In this example, most of the individuals in group 218 were matched to individuals described in database 206. In other embodiments, it is possible no matches may be found. In yet other embodiments, it is possible that all of the individuals in a group, such as 218, can be matched to individuals in the database 206. Thus, the fractions shown in FIG. 3 are for the purposes of illustration only and are not meant to be limiting.

The system 12 can maintain a number of databases that identify individuals. The individuals can have different job skills and may be members of different professions. At some point, the system 12 may have received information that allows a score or a rank to be developed for the individual. In various embodiments, the scores or ranks can be an indicator of such factors, as the quality of their one or more job skills, their influence within their profession and their effectiveness at their profession.

When reporting the results of a search, the system 12 can report which individuals received in a group, such as 218, were matched to an individual in at least one database maintained at 12 and which individuals were not matched. For named individuals in a group that are matched to someone in the developer database 206 a confidence measure can be determined. The confidence measure may be based upon the amount of information that is matched. For example, a number of points can be given for a last name match, a number of points can be given for a first and last name match and a number of points can be given for each e-mail address match. The more information that is matched the higher score and hence the higher level of confidence that the named individual is a match for an individual in the developer database 206.

In one embodiment, when an individual is not matched or the confidence measure is determined to below a certain threshold, the system 12 can be configured to initiate a search and attempt to locate information about a named individual in a group that allows them to be scored or ranked or raises the confidence measure of the match to an individual in the database 206. A named individual newly scored or ranked can be added to the database 206 and their score/rank can be reported in reply to the service request, such as in 212 or 216. When a confidence measure of a match has been increased as a result of search such that it exceeds threshold value for reporting the result, then the result can be reported in a reply to the recruitment service request.

In one embodiment, when a named individual can't be located in the database 206 and information about the named individual can't be found which allows the individual to be scored or ranked, the system 12 can still be configured to keep a record of the individual. The system may keep the information so that future searches can be carried out in which attempts are made to gather information on the named individual where the gathered information can be used to develop a score or rank for the individual. Further, if the named individual shows up again as a result of a request from another entity to score the individual, then the system 12 can report that an individual may be actively looking for a job based upon the fact that the system 12 has received information about the individual from multiple entities. This information can be provided even if a score or rank is not available for the named individual.

In one embodiment, when a match is not found for a named individual in a service request and a record of the unmatched named individual is stored, the system can be configured to attempt to match the named individual at a later time. It is possible a match may be subsequently found and a score or ranking may become available for the named individual that was not previously matched. The system 12 can be configured to report the score or ranking to one or more entities that requested a score or ranking for the named individual that originally were notified that a score or ranking was not available for the individual or the confidence level of the match was below a threshold value when a score or ranking becomes subsequently available. This feature may be a system option in that a service requester can specify whether they wish to be updated or not if additional information is subsequently discovered about a named individual, such as whether a score or ranking has been developed for the name individual that was previously not available.

In general, the system can be configured to allow the recruitment service requester to specify whether or not they want updates regarding named individuals that have been previously submitted in a service request, such as 210 or 214. For example, the system can be configured to maintain a watch list for an entity including a number of named individuals in a group. In response to specified triggers, the system 12 can be configured to notify the entity. For instance, the system can notify an entity, such as recruiter, when it is determined a named individual on the watch list appears to be searching for a job. In another example, the system can be configured to notify an entity, when a score or ranking of an individual on the watch list has changed in some manner, such as exceeding some threshold value or changing by some percent amount.

The notifications from system 12 can occur through one or more different communications channels. For example, an e-mail can be sent to a recruiter. In another example, a text message can be sent to a recruiter's portable electronic device. In yet another example, an e-mail and text message can both be sent.

The system 12 can be configured to receive in a request for a recruitment service subsets of named individuals grouped in some manner. The named groups may be used for comparison purposes. These different subsets are represented by the circles in FIG. 3 that are smaller than the largest circle. As described above, the largest circle can represent individuals in the developer database 206 and portions of the smaller circles lying outside of the largest circle represent named individuals in a group that have not been matched to an individual in the developer database 206.

In one example, the recruitment service request 210 for ranking/scoring of individuals can include groups 218, 220, 230 and 232. The named individuals in group 218 are possible job candidates. These candidates may have applied for a job over a first time period, such as in the last year. Group 220 may be individuals that are distinct from other members of group 218 in some manner, such as having applied for a job in the last month or having applied for a job multiple times. Group 230 can include individuals that have been offered a job. Group 232 can include individuals that have been hired.

In another example, the recruiting service request 214 can include three specified groups, 224, 226 and 228. Group 224 can be a group of individuals that have applied for jobs in between 6 months to a year ago. Group 226 can be individuals that have applied more recently for a job or jobs, such as within the last month. Group 228 can represent a current employees of a company that perform a job or jobs that are similar to the job or jobs for which the named individuals in group 228 are applying.

In one embodiment, scores/ranks can be provided for each individual in a group as well as for the group as whole (e.g., an average score for the named individuals in a group can be provided). The scores/ranks can be used for various comparison purposes. For example, the score of a named individual in the recent 220 group can be compared to the average score or rank of the hired individuals in group 232 or the average score or rank of the individuals that were offered jobs in group 230. Similar comparisons can also be made between individuals in groups 224, 226 and 228. For example, scores/ranks of a named individual in group 226 that has recently applied for a job can be compared to scores/ranks of individuals in group 228 or an average of scores/ranks for individuals in group 228. In another example, the average rank/scores of the individuals in group 224 that have applied 6 to 12 months ago can be compared to another group, such as individuals in group 220 that have applied for a job in the last month.

In one embodiment, this comparison feature can be used as a filter. For example, the system 12 can be configured to only return information on named individuals in a group whose score or rank is above the average of the named individuals of a comparison group. As another example, the system 12 can be configured to only return information on named individuals in a group whose score/rank is above some threshold value, such as the average score/rank of the named individuals in a group.

In the examples in FIG. 3, some of the named individuals that are submitted in different recruitment service requests can overlap. For instance, some of the named individuals in group 218 can also be named individuals in group 224. In FIG. 3, the overlap of members for groups 218 and 224 is represented by the intersections of the circle 222. In example in FIG. 3, the entity associated 202 and the entity associated with 208 may not be aware of their individual recruitment service requests and the fact one or more individuals are in each request as different entities, such as companies don't share this information. However, when a named individual is identified from multiple recruitment service requests, the system 12 can be configured to keep track of and leverage this information.

As an example, the system can be configured to record each time an individual appears in a recruitment service request. If a named individual appears multiple times over some period, it can indicate the candidate is looking for a job. If the named individual is highly ranked, this factor can be used as a trigger to notify a recruiter. For instance, as described above, a recruiter can place an individual on a watch list and request to be notified under some conditions. One of the conditions can be if the individual appears to be looking for a job which may be determined from their appearance in multiple recruitment service requests. The system 12 can be configured to allow a user to specify parameters that determine under what conditions they are to be notified.

In a recruitment service request, such as 210 or 214, a large number of names can be submitted. For example, tens of thousands of names can be submitted. The processing of a large group may take a significant amount of time. In one embodiment, the system 12 can be configured to provide results of a recruitment service request all at once. For example, the system 12 can be configured to process all of the named individuals in a recruitment service request and then return the results in a batch mode when request is completed. In another embodiment, the system 12 can be configured to send a portion of the results in real-time before the request is completed. For example, when a match is made for a named individual in a recruitment service request, the results can be returned as soon as the match has been made. As another example, when a match is made for a named individual meeting certain criteria (e.g., a ranking or score about some specified value), the results can be returned as soon as the match is made. The remaining results including or not including individual results previously sent can be returned in a batch mode when the matching process for the recruitment service request is completed.

The format of the returned results can vary. In one embodiment, a selectable link can be provided that allows additional information to be learned about an individual listed in a result. This information can include information that has been gathered by system 12. In one embodiment, a recruiter can provide filtering requirements that affect the additional information that is returned from the system. For instance, the recruiter can specify in accordance with a company policy that protected class information or images associated with identified individuals are not to be returned. In response, the system 12 can filter out this information from the additional information it has on particular individuals before it is returned to the recruiter. Additional details of this process are described below with respect to FIGS. 5-9.

In one embodiment, the plug-in, such as 204 or 206, can be configured to automatically submit recruitment service requests to the system 12. For example, each time an individual applies for a job and their information is entered into the ATS 202, plug-in 204 can be configured to submit a recruitment service request to system 12. When a match is found, the system 12 can return information, such as a score or ranking, about the individual and additional information that is filtered according to parameters specified by the recruiter. The returned information may be stored to the ATS. In another example, the recruitment service request can be triggered after some number of applicants have applied, such as after receiving 10 applications. Then, the plug-in module can send a recruitment service request including ten names to system 12. In another example, the recruitment service request from the ATS can be triggered at some time interval, such as once a day.

In the example above, one or more named individuals are described as being sent in a recruitment service request to system 12, the system 12 tries to match the named individual to an individual stored in a database, such as database 206, and then information, such as scores for matched individuals can be returned. The use of the service is described with respect to recruiting individual candidates for jobs. However, the use of the system is not limited to recruiting individual candidates for jobs.

For example, in one embodiment, the system 12 can be used to rank or score the strength of a team, such as a software development team. An employer may have a number of software development teams for different products. The individuals on each team can be submitted to system 12 and the development team can be scored. Based upon the scores, a manager may decide to reformulate the groups. For instance, some development teams have much higher scores than other development teams and a manager may reshuffle the team members such that the scores for the teams are more balanced.

In another example, a company may wish to hire a team of developers for a project. The company may receive bids from different contractors. The company can request the names of individuals that are going to be working the project for each contractor and submit their names to the recruitment enhancement system 12. The system can return scores for each of the development teams for each contractor. Based upon the scores/rankings provided for each of the team members as well as the scores as a group, the company can decide which contractor to hire for the project.

In yet another example, a company, such as a software contractor, may have their software developers ranked/scored by system 12. The system 12 can generate individual scores. The individual scores can be used to develop company scores. Then, the company may use individual scores and/or the company scores to promote the technical expertise of their employees.

As described above in response to a recruitment service request including a number of named individuals, such as 210 or 214, results which may include scores and/or ranks can be returned to the requester in 212 and or 216. An example of what information can be returned is described as follows with respect to FIG. 4B. Other types of information can be returned and the example provided in FIG. 4B is for the purposes of illustration only.

In one embodiment, the individual output data 350 can include some set of baseline information and optional information. As an example, the baseline information can include a link to a profile 352 or the information contained in a profile. The profile 352 can be a profile collated from various information sources to which system 12 has access, such as various on-line sources. The baseline information can include one or more scores, such as 354 and 356, skills possessed by the individual and an indicator 360 of the confidence measure of the match. The confidence measure can be indicated as a score, such as a numerical score, or according to some scale, such as high, medium or low.

Returning to FIG. 4B, some examples of optional information include one or more social profile links 362, additional contact information 364 and a current job status 366. The additional candidate information can be information that the system has obtained from publically available source. For example, the additional candidate information 368 may consist of blog posts, tweets and status updates that the candidate has posted to the web over time and the system has gathered via crawling or scraping of various web-sites. When the additional candidate information is selected, it can be presented to the user. As described below, the information can be filtered before it is selected. The formulation of the baseline information is provided for illustrative purposes only and different combinations of baseline information and optional information can be provided

In one embodiment, the system 12 can be configured to receive parameters that allow a user to customize the information and the format of the information that is received in 350. The customization may be implemented on a request by request basis, implemented globally as part of the plug-in module or implemented on a user by user basis For example, a first user can specify one set of preferences and a second user may specify a second set of preferences for receiving information 350 where the preferences can affect the type of information that is received and its format. One example of customization can be only returning information that can be used to make legal hiring decisions. Information that can be used to make an illegal decision, such as gender, health status or age related information, may be blocked such that the information is not output via the system.

In one embodiment, for a large job including information about many individuals, the system 12 can electronically send a report or a link to location that allows the report to be downloaded when the report is ready. In addition, the plug-in modules, such as 204 and 206, can be configured to add all or a portion of the information in the report to an ATS. For example, scoring results can be integrated into the ATS such that future searches involving the ATS can return scoring information without having to contact the recruitment enhancement system 12. The plug-in module can be configured to periodically communicate with the recruitment enhancement system to update the scores or ranks stored to the ATS. Additional details of a recruitment enhancement system are described in U.S. applications Ser. Nos. 13/557,812, titled, “Method and Apparatus for Enhancing Job Recruiting,” and 13/568,493, titled, “Method and Apparatus for Electronic Job Recruiting,” each of which are incorporated by reference and for all purposes.

Gathering and Filtering Aggregated Individual Information

As described above, information from a number of publically available sources, such as social media sites or professional sites, can be gathered, aggregated and analyzed for various individuals. The system can provide filters for the data that can applied at different stages in the recruitment process, such as before storing data to the system or prior to viewing previously stored data. The filters can be used to identify and return certain types of information and/or prevent certain types of information from being returned. The filters that are applied can depend on the context in which the information is to be used, such as according to a stage in the recruitment process. Some examples of how information filters may vary depending on the stage in the recruitment process or post recruitment process are described in the following paragraph.

In many recruitment scenarios, a candidate is a prospect in that the person has not formally applied for a job. The recruiter in such a scenario is thus searching for individuals to contact. Under the labor laws of many countries, the regulations for the type of information used to identify a prospect are generally less stringent than using acquired information after an individual has applied for a job. Thus, no filtering or minimal filtering may be required in this context. However, stricter standards may apply in some countries regarding the types of information that may be used to evaluate current employees. Thus, to comply with these regulations more stringent filtering may be used. Further, during the hiring a process, a different set of regulations may apply which may require different filtering. Moreover, individual countries have different laws regarding how self-authored writings of an individual may be used in different employment scenarios. Additionally, there have historically been certain professions in which a condition of employment included the expectation that a very wide range of personal information could be collected and evaluated (e.g., psychological testing for firefighters). Thus, depending on the context, it may be appropriate to present more or less aggregated individual information to a user of the recruitment enhance system where the amount of information that is provided depends on the amount of filtering that is used.

As will be discussed in more detail with respect to FIGS. 5, 6, 7, 8 and 9, apparatus and methods are described for gathering information on individuals and then filtering the information prior to output to account for the context in which the information is being used. In a particular embodiment, when the aggregated individual information is being used for making decisions that may affect whether an individual is hired or not, the information can be filtered for “protected class information.” The filtering of the protected class information can prevent inferences from being made that the information is being used in a discriminatory manner, i.e., someone is not being hired as a result of being a member of a protected class. For example, if the individual making the hiring doesn't know anything about an individual's protected classes, then the individual can't be accused of making an illegal hiring decision based upon this information.

Referring to FIG. 5, in one embodiment a portion of the recruitment enhancement system 12 (or other computer system including a processor and a non-transitory computer readable memory storing instructions) can use a spider to crawl links to content authored by the candidate (e.g., social media) in step 405. The Internet is crawled with a spider and content is downloaded to a database (DB) and associated with an individual user in step 410. As examples, the content may include text extracted from social media, such as blogs and Twitter® posts. Text equivalents of video or audio posts may also be generated. Additionally, the content may include articles available on the Internet written by the individual. Examples of sites that can be crawled include but are not limited to Facebook™, Myspace™, Google+™ Twitter™, Pinterest™, Linkedin™, Github™, etc

The collection of content may be performed in view of other contextual information, such as crawling the Internet searching for individuals having certain educational qualifications, job-related qualifications, or business opportunity qualifications to form an initial pool of potential candidates from which additional information for specific individuals is desired. Alternately, the collection of data may be performed for a specific individual whose identity is already known. For example, in response to request from a recruiter that wishes to learn additional information about an individual. In one embodiment, the crawling can be performed on a regular basis and used to update a database that is maintained by the system, such as daily, weekly monthly, etc. In another embodiment, all or portion of the information can be gathered on demand to ensure that the information that is being gathered is up to date.

The analysis of content preferably uses filtering techniques to verify authorship, such as filtering out re-posts on social media (e.g., filtering out “retweets” of Twitter® postings). Additionally, the filtering may include verification tests to verify that the content is associated with a single individual and not misattributed from other individuals having similar names. The analysis of the content may be performed over a selected time range and trend analysis may also be performed if there is sufficient historical data.

In one embodiment, a natural language module may be used in step 415 to process the text. The text can be manipulated using natural language processing, such as determining a frequency of detected keywords and correlations and semantic associations between words. The semantic association between words can be used to filter certain types of information, such as protected class information. For instance, a descriptions related to a person's medical status may be removed based upon identifying key words and semantic associations. An exemplary tool for performing natural language processing of text is the Natural Language Toolkit (NLTK) from the NLTK Group for use with Python® programming. NLTK provides a suite of processing libraries for performing computational linguistics for linguistic classification, tokenization, stemming, tagging, parsing, and semantic reasoning.

In another embodiment, a Machine Learning (ML) module can be used in step 420 to classify the text associated with a particular individual and obtain additional information to assess the potential interest and potential fit of an individual for a job. ML is branch of artificial intelligence which includes algorithms enabling software to learn. ML is used to classify content associated with a particular individual. ML programs perform classification based on training to find a pattern based on the training. ML typically generates results in which there is certain probability of a particular classification being correct. If the result is over a specific threshold, a particular classification is assigned. As an example, a classification can be provided as to whether the information is protected class information or not.

After the information is gathered and aggregated for one or more individuals, the aggregated individual information can be filtered before it is output. For example, the information can be filtered to remove protected class information. In one embodiment, the filtering can be performed before the data is uploaded to the system so that certain types of information may not be uploaded to the system. An example of outputting the information is described above with respect to FIG. 4B. A method 500 of performing the filtering is described as follows with respect to FIGS. 6 and 7.

In 502, the system can attempt to make a determination of the context in which the aggregated individual information is to be utilized. For example, the system can output to a display a question to the user, such as “How is the information to be used,” followed by a number of selectable options. The selectable options can be indicative of the stage of the recruiting process in which the information is to be used. Examples of the selectable options can be “Outside of the hiring process for a particular job-general networking,” “Within the hiring process for a particular job-initial candidate search and screening,” “Within the hiring process for a particular job-pre-candidate interview,” or “Within the hiring process for a particular job-post interview.”

A selection of these options can affect filtering settings that are to be applied to the aggregated individual information that has been gathered. For example, if the selection is outside the hiring process for a particular job, the default filtering setting may be “no filtering.” For “within the hiring process for a particular job-initial candidate search,” the default filtering setting may be federal protected class information for the United States. Federal protected class information is one of information associated with race, color, national origin, religion sex (including pregnancy, childbirth, and related medical conditions), disability, age (40 and older), citizenship status and genetic information.

After filtering is applied, an interface can be provided that allows a user to view and adjust the filtered information. The interface can display the results of the filtering process performed by the system. If the filter doesn't completely remove all of the protected class information, using the interface, a user may able to remove and then save the manually filtered information associated with a particular individual for later viewing, such as by a hiring manager.

When the “within the hiring process for a particular job-pre-candidate interview” option is selected, the system can be configured to return the filtered aggregate individual information generated during the pre-screening process described in the previous paragraph. Some companies may require that a person different from the individual with hiring power perform the initial candidate search and screening for a particular job. In one embodiment, when the initial candidate search and screening has not been performed and this option is selected, the system can be configured to not return any data and notify the person that pre-screening needs to be performed. This configuration may prevent a hiring manager from seeing information that has not been approved for viewing by the hiring manager at particular stage in the recruiting process, such as protected class information prior to determining whether to interview a candidate or not.

Finally, when the “within the hiring process-post interview” option is selected, in one embodiment, less filtering may be used allowing some or a portion of the protected class information to be returned. This option may be allowed because during the interview the interviewer may have learned protected class information, such as gender and race, just by seeing the person. Thus, it may no longer necessary to filter out this data. Therefore, the system can be configured to return less filtered information on an individual at the post-interview stage. In one embodiment, this option can be company specific, i.e., one company may allow more data to be seen after the interview whereas some other companies may still only permit a user to see information filtered for the protected class information after the interview.

In 504, the system can receive location information. The location information can be used to adjust filter settings. For example, the location information can be country, such as the USA or a region, such as Europe, where the employment is to take place. Different countries can have different requirements in regards to what information can be considered in the hiring process as well as privacy protections for their citizens. Thus, based upon the location setting some default filtering settings pertinent to the location can be retrieved.

In one embodiment, when the USA is specified, the system may allow a user to select a state. Many states have protected classes that are beyond the federally mandated protected classes. For example, California in addition to the federal protected classes includes protections based upon marital status, sexual orientation and identity, AIDS/HIV status, medical conditions and political activities or affiliations. In Minnesota, marital status, sexual orientation, creed, status with regard to public assistance, membership or activity in a local human rights commission, are additional protected classes. In addition in Minnesota, it is generally unlawful to refuse to hire an individual because of his or her use of lawful consumable products during nonworking hours off the employer's premises. Thus, as an example, for a potential Minnesota hire, the system can be configured to filter out any information related to drinking or smoking.

In Wisconsin, marital status, ancestry, sexual orientation, arrest record, conviction record, military service, genetic testing, the use or nonuse of lawful products off the employer's premises, or declining to attend a meeting or participate in any communication about religious or political matters are protected. Also, arrest and conviction records may be considered only in certain limited circumstances. For North Dakota, presence of any mental or physical disability, status with regard to marriage or public assistance, or participation in lawful activity off the employer's premises during nonworking hours that is not in direct conflict with the essential business-related interests of the employer may be protected. In South Dakota, marriage or public assistance, or participation in lawful activity off the employer's premises during nonworking hours is protected. Finally, in Iowa, sexual orientation and gender identity. These examples are provided for illustrative and are not meant to be limiting to only the states listed above as other states not listed also can have protected classes beyond what is federally mandated.

As mentioned above, different countries can have different rules. For example, in Canada, human rights laws across prohibit employers from discriminating against individuals in hiring, firing, or the terms and conditions of employment because of certain personal characteristics (unless it is for a valid job requirement). With some exceptions, workers in Canada are protected from discrimination based on: 1) national or ethnic origin, race, ancestry, place of origin, color; 2) disability (physical and/or mental), 3) religion, creed, political belief, association, 4) sex, sexual orientation, pregnancy, 5) age (with exceptions for minors and seniors in some cases) and 6) marital or family status. Canadian labor laws prohibit discrimination against any person for union activity or because of union membership. You can't be treated unfairly or differently because of your association with a union. The provinces, the territories, and the federal government all have slightly different laws. Some jurisdictions protect workers from discrimination on additional grounds, such as language, social status, or previous convictions for which a pardon has been granted. Thus, the system can be configured to apply certain filtering settings when Canada and/or a specific province of Canada are entered into the system.

Another factor (not shown in FIG. 6) which can affect the filtering of the individual data is the number of employees in a company. Certain laws only apply to companies of a certain size. For example, under federal law, companies with 15 or more employees are covered by Title VII, the primary law prohibiting employment discrimination, the Americans with Disabilities Act, which prohibits discrimination on the basis of disability, and the Genetic Information Nondiscrimination Act, which prohibits discrimination based on genetic information. Companies with 20 or more employees are subject to the Age Discrimination in Employment Act (ADEA), the federal law that prohibits discrimination against employees 40 years or older. Companies with four or more employees must comply with the employment discrimination provisions of the Immigration Reform and Control Act, which prohibits discrimination on the basis of citizenship status. Thus, in one embodiment, the number of employees of a company can be an input.

Based upon the input of the number of employees, the system may set default filtering settings and/or indicate which laws are applicable. For example, if the input is 10 employees. The system may set filters that remove only citizenship status information. As another example, for 17 employees, the system set filters that remove information associated with Title VII and citizenship status but not age related information that comes into effect at twenty employees.

Besides protected class information, there are certain rules related to financial status that may be enforced. For example, when a person has been involved in a bankruptcy, it may be desirable not to use this information in a hiring decision. Thus, in particular embodiments, the system can be configured to remove financial related information, such as whether they have gone bankrupt before or not.

In 506, the system can receive user information. In one embodiment, the user information can be used to determine one or more filtering settings. For example, in one embodiment, the user may have saved some combination of filtering settings and the saved filtering settings can be recalled when the user information is provided. In another example, the user may have saved a number of different filtering settings. When the user information is provided, the system can display a list of their saved filtering settings. Then, a user can select one of the saved filtering settings to utilize.

In yet another example, the user information may link the person to a particular company. The particular company may have a default filtering setting associated with a company policy for filtering. When the user information is received and it the company is determined a default company policy for filtering can be located and applied. As an example, a multistate company may have a filtering policy that is consistent with a state in which they are located that has the most protected class requirements. As another example, a company, as a matter of policy, may choose to recognize more protected classes than are required United States federal regulations.

In another example, via the user information, a user can be granted more less privileges with the system. For example, a first person can be granted the privilege to view unfiltered information about candidates, such as a person in charge or pre-screening but not hiring. However, a second person, such as a person expected to make hiring decisions may be allowed to view only filtered information according to some privilege setting that is determined from the user information that they have provided to the system.

In 508, based upon the information received in 502, 504 and 506, the system can determine a number of default filter settings. In 510, the system can be configured to display the default filter settings that are to be utilized. In 512, the system can be configured to receive custom setting. For example, a user may decide to remove one of the default settings determined in 508. In another example, a user may decide to add additional setting beyond the default settings determined in 510. In one embodiment, the interface may allow a user to select filtering setting to add to the default settings or remove from the default settings that have been determined by the system. For example, a default setting may be to filter image data and the user can remove this filter setting to allow image data to be viewed or a default setting may be to allow viewing of image data and the setting can be changed to no image data.

Filtering image data can involve determining whether an image is safe or unsafe for use in a hiring decision. For example, an image of a person applying for a job may be considered unsafe to use in a hiring decision and the system can be configured to identify images including the person applying or people and prevent such images from being output. However, an image of project a person completed may be considered safe to use in a hiring decision. Thus, the system may allow such an image to be output. Thus, in general, the system may be configured to discern whether certain images are safe or unsafe to use in a hiring decision and hence whether the images are to be output or not output.

In one embodiment, the system may include a number of examples of individual profiles that a user can view unfiltered and then again with one or more combinations of filtering settings applied. The interface can be configured to display the individual profiles and the associated filtering settings that have been used to generate the profiles in a side by side manner to allow a user to see the effects when different filtering settings are applied. For example, the system can be display an unfiltered profile in a side by side manner with a profile generated from the default filtering settings determined by the system in 510.

In 514, the system can receive a confirmation of the setting and then store of record of the settings if desired. As described above, the user may store a combination of filtering setting which they may later wish to re-use. Next, the system can apply the filtering settings that have been selected. For example, a user can provide a list of names of a number of different individuals and other types of identification information, such as e-mail addresses, associated with each individual. Next, the system can attempt to retrieve from a database or search the web for individuals satisfying the received identification information as described above with respect to FIG. 5.

After gathering the information on the individual, the system can filter the information according to the specified filtering settings confirmed in 514. For example, all information associated with age can be removed, such as a birth date, a date when they graduated high school or an image of the person. As another example, all references to marital status or references to health conditions and overall health can be removed. In yet another example, all references that might indicate gender can be removed. For instance, if the person indicated they were a member of women's hockey team, the system might return that the individual was a member of a hockey team.

In 516, the system can present aggregated individual information that has been filtered. The information can be presented for one or more individuals. In one embodiment, the system may have an interface that allows a user to remove additional information about a particular individual. For example, if the system returned information about a person drinking in a legal setting and it was not caught by the filtering, the system might allow the user to remove this information for a displayed profile. A person prescreening profiles for a hiring manager can perform this task before the hiring manager is allowed to see the filtered profiles.

In one embodiment, when a person manually removes information, the system can be configured to determine whether other profiles of interest to the user have similar information. If other profiles have this type of information, the system can query a user to ask whether they would like the system to remove the similar information in the other profiles. When the system receives an approval, it can then apply the manual changes performed by the person for one profile to the other profiles.

In 518, the system can be configured to store the filtered information. For example, a user performing pre-screening for a hiring manager may request the system to store the filtered profiles for later review by the hiring manager. Optionally, the system can also store the unfiltered data to allow someone in a later stage in the hiring process, such as after a candidate has interviewed.

In one embodiment, the types of unfiltered data that are saved can be specified. For instance, a user can specify that the system save an image of the user that can be later viewed after interview. However, the user may specify that no information related to citizenship status of the individual be saved. Thus, a person later reviewing the saved profiles can be kept from seeing this additional data about the individual in their profile.

With respect to FIG. 7, additional details of a method 600 for gathering content associated with different individual and identifying when all or a portion of the gathered content provides information undesirable for use in a hiring decision. As described above, whether the information is undesirable for use in a hiring decision may depend on the stage of the hiring process in which it is to be utilized. Thus, in some embodiments, different filters can be applied at different stages in the hiring process. In other embodiments, the same level of filtering can be applied throughout the hiring process.

In step 602, content can be gathered that can be used to a train a filter for identifying certain types of content. In one embodiment, the filter can be Bayesian type filter. A Bayesian type filter uses a statistical technique for identifying one or more particular types of content. It can make use of a naive Bayes classifier to identify particular types of content. Bayesian classifiers work by correlating the use of tokens (typically words, or sometimes other things), with “a particular type of content” and “not the type of content” and then using Bayesian inference to calculate a probability that a unit of content includes or does not include the type of content. As an example, the Bayesian classifier can be developed that identifies whether a unit of content includes or doesn't include information associated with one or more protected classes. This type of analysis can be applied to text, audio files or video files where filters can be applied to the words in the text, audio or video files.

As an example, the identification of protected class information using a Bayesian type filter is described. However, other types of information can be identified using a Bayesian type filter and this example is provided for the purposes of illustration and is not meant to be limiting. For example, as described above, a filter can be developed to identify financial information, such as bankruptcy information.

In a Bayesian filter, particular words may have particular probabilities of occurring in unit of content including protected class information as opposed to a unit content not including protected class information. For instance, near an individual's birthday, an individual may post content to a social media site including words, such as “my”, “birthday,” “50,” “fifty,” “year,” “age,” and “old.” These words may be encountered more frequently in units of content where a person is talking about their age (e.g., fifty) as opposed to a unit of content where a person is not talking about their age. When an individual is forty or over, the individual is part of a protected class in the United States. Thus, probabilities can be assigned to these words and used to determine whether the unit of content that is being analyzed includes protected class information, such as whether the person is over forty.

A unit of content that is analyzed can vary. For example, a unit of content may be a tweet which has an upper limit on the amount characters. A comment on a social media site, such as a Facebook™ wall may include one or more sentences. A blog post may include multiple sentences and multiple paragraphs. In one embodiment, a unit of content can be analyzed as a whole such that a probability of the unit of content including a particular type of content is determined. In another embodiment, a unit of content can be divided into a number of portions, such as sentences or paragraphs, and each portion can be analyzed to determine whether the portion includes a particular type of content.

In the instance where portions are analyzed, the system can be configured to perform operations based on the portions. For instance, in the instance where any portion of a unit of content is determined to have a probability of above a threshold value of including a particular type of content, the system can be configured to operate on the entire unit of content as a whole, such as blocking from output the entire unit of content. As another example, the system can be configured to operate on the portions of a unit of content on a portion by portion basis. For example, in a blog post including multiple paragraphs, where each sentence is analyzed for a particular type of content, the system can be configured to output only paragraphs not identified as having protected class content.

The filter doesn't know these probabilities in advance, and must first be trained so it can build them up. Thus, in 602, a number of content units that contain and don't particular content types such as protected class information can be provided. To train the filter, in 602, the system can receive indications in 604 of whether the content unit includes a particular type of content or not, such as protected class information. In one embodiment, these indications can be generated manually, i.e., the determination can be made based upon one or more humans reviewing the content and providing some indication to the system of whether it contains the particular type of content or not.

In 606, for all words in each training content unit, the filter can adjust the probabilities that each word will appear in a content unit including a particular type of content or a content unit not including the content. For instance, a Bayesian filter may typically have learned a very high probability for the words “Christian” and “Bible”, to indicate the content unit includes religious content but a very low probability for words seen only in content unit including non-religious content, such as the names of types of food. When a word first appears that has not been previously seen, the system can define it a default probability. Then, as additional indicators are received, such as its appearance in a content unit identified as including a particular content type or not including a particular type of content, a probability associated with the word relative to the particular content type can be adjusted.

Bayesian filters can be constructed by assigning probabilities on a word-by-word basis. Other types of filters can be constructed that assign probabilities to groups of phrases appearing or not appearing in content units that include a certain type of content. For example, a probability can be assigned to the phrase “my birthday” as being in a content unit including information about someone's age as opposed to assigning probabilities to the words, “my” and “birthday” separately. Thus, in the embodiments described herein, probabilities can be assigned to words individually and/or word phrases for the purposes of determining whether a particular content unit includes a particular content type or not.

After training, the word probabilities (also known as likelihood functions) are used to compute the probability that a content unit with a particular set of words in it belongs to either category associated with the filter. Each word in the content unit can contribute to determining the content unit's probability of being in a category, or only the most interesting words may be used to contribute to the probability. This contribution is called the posterior probability and is computed using Bayes' theorem. When, the content unit's probability is computed over all or a portion of the words in the content unit, and if the total exceeds a certain threshold (say 95%), the filter will can mark the content unit as including or not including the particular type of content.

In one embodiment, the calculated probability or probabilities can be saved so that they don't have to be calculated each time. As described below, the system can be configured to allow an entity to specify a different threshold values. Thus, depending on the threshold values specified by an entity, a content unit may or may not be tagged as including a particular content type. Once the probability is determined for a content unit a first time for a particular filter, the probability can be reused without its recalculation to check against different threshold values specified by different entities.

In 606, one or more filters can be trained. For example, in the case of protected class information, a filter can be trained to determine a probability that a content unit includes information related to age, nation of origin, health condition, gender and genetic conditions (i.e., protected class information). The filter can be trained to determine a probability that the content unit includes any of these content types. In another example, a first filter can be trained to determine a probability of whether a content unit includes age information about an individual, a second filter can be trained to estimate a probability of whether a content unit includes nation of origin information about an individual, a third filter can be trained to estimate a probability that the content unit includes health condition information about an individual, a fourth filter can be trained to estimate a probability that the content unit includes information about the individual's gender and a fifth filter can be trained to determine to estimate a probability that the content unit includes genetic information about an individual. Each of these filters can be applied to a content unit to estimate whether the content unit includes or doesn't include the aforementioned information associated with each filter.

As described above, for the United States, a default set of protected classes is specified at the federal level and then individual states may specify additional protected classes that can't be used to affect hiring decision. Thus, in one embodiment, a first filter can be trained to recognize the federal protected classes and then additional filters can be trained for each of the additional state requirements. In another embodiment, a filter can be trained for each state's requirements, respectively, where the filter is configured to determine a probability of whether a content unit includes information related to any of the protected classes associated with a particular state. As described above, in general different countries and localities within countries may have different rules regarding what information may or may not be used in a hiring decision and different filters can be trained to identify this information at a country level and in addition at a local level.

As described above, different entities (e.g., companies) may have different rules for viewing content in a content unit. In one embodiment, different filters can be trained for different entities depending on these rules. In another embodiments, a set of filters can be trained and then an entity can specify whether all or a portion of filters are to be applied and under what circumstances the filters are to be applied, such as what combination of filters are to be applied in the candidate identification phase as opposed to what combinations of filters are to be applied in post interview phase. In one embodiment, as described above, the same level of filtering may be applied throughout the hiring process.

In 608, the system can gather and/or update content units attributed to various individuals, such as blog posts. The content can be stored to a database in the recruitment enhancement system. In one embodiment, descriptive metadata, such as a title can be associated with a content unit. For example, a blog post can have a title. In one embodiment, filtering, such as Bayesian filtering, can be applied separately to the metadata (e.g., title) as well as the body of content associated with the metadata where the probabilities assigned to words in the metadata are different or the same as the probabilities assigned to words in the body of content.

In 610, the system can receive filtering parameters to be utilized. For example, filtering parameters can be one or more different filters to apply and a filter threshold associated with the filter. In particular embodiment, the filter thresholds can be different for each filter. In one embodiment, the system can be configured to receive a number on a scale (e.g., 0-4) or a qualitative description of a scale, such low, medium or high, where a threshold value can be assigned to the number or qualitative descriptor. For instance, a value of “1” may correspond to a threshold value of 20% whereas the descriptor, “high,” may correspond to a value of “80%.”

In one embodiment, an entity, such as a company, can have specific filter parameters that are to be used when someone is carrying out hiring related tasks. Users of the system can provide information that allows them to be identified with a particular entity. When the user is identified, the system can determine whether they are associated with a particular entity and look up appropriate filter parameters for the entity and apply them to the user's activities in the recruitment enhancement system that require content filtering.

In 612, the system can receive search parameters or some other metrics (e.g., a list of names) that causes the system to locate content for a number of different individuals, such as individuals maintained in a database at the recruitment enhancement system. In 614, the system can retrieve content for the one or more individuals. As described above, the content may be content generated by the individuals, such as blog posts or tweets, which can be retrieved by the system.

In another embodiment, as is described in more detail below, the system can tabulate a frequency of certain words or combinations of words appearing in an individual's social media content and/or resume. Filters can be developed to remove words that may influence a hiring decision in an unadvisable way (e.g., one that could lead to a lawsuit). As an example, words or combination of words related to or which can be associated with a protected class can be removed. For example, the words “pregnant” or “cancer” can be removed as it could lead to a hiring decision considered discriminatory.

In 616, the system can determine a probability that content in a content unit falls into a particular category, such as including or not including protected class information. In one embodiment, this probability may have been already determined for the content unit and stored by the system. Thus, the system may simply retrieve the value associated with the content unit. As described above, the content unit can be a word, a combination of words, a sentence, a paragraph, multiple paragraphs, a portion of speech analyzed from an audio track, etc. For an individual, the system can be configured to gather and analyze different content unit types generated by the individual.

In 618, the system can tag content as being in a particular category based upon the determined probabilities and threshold values. For example, when a threshold value is 80% and a probability determined from a filter for identifying protected class information for a content unit is greater than 80%, the system can tag the content unit as including protected class information. If the user has requested that content units including information tagged by the filter not to be displayed, then the system does not output the content unit. In other examples, the user may be looking for content units having a particular content type. In this example, the system may only output information the content units tagged as containing the particular type of content.

In 620, the system can assemble filtered content for one or more individuals. The assembled content may be required to be tagged or not tagged in a certain manner. The assembled filtered information can be written to a file and optionally made available via a graphical user interface (e.g., see FIGS. 8A and 8B). For instance, a list of names can be presented and when a user selects the name or some other indicator in the interface, the assembled filtered information for each individual can be output via the interface.

A mechanism can be provided that allows a user to indicate and/or remove improperly tagged information. For example, content units can be filtered for protected class information where only content units tagged as not including protected class information are output. If a content unit is output that a user identifies as having protected class information, the system can receive an indication of this determination and remove the content if desired from the interface and optionally a file if the content has been written to a file.

In one embodiment, the system can provide an interface that allows a user to view content that has been tagged or not tagged in a certain manner. For example, the system may allow the user to view content that has been tagged as including protected class information from a particular search. The viewer may wish to view this information to determine how well the system is filtering based upon the specified threshold parameters used for the tagging.

As described above, the filtering may be performed to prevent a user from viewing particular categories of information for certain individuals. When the system displays tagged information that a user doesn't generally doesn't want to see for a particular individual but still wants to assess the filtering performed by the system, it can be anonymized in some manner. For example, the order of the tagged content can be randomized so that it doesn't correspond to the order of the individuals identified in the search. Further, if desired, such as when the number of individuals in the search is small, the tagged content can be mixed with tagged content from individuals not identified in a search so that the person reviewing the content that was tagged as being or not being in a particular category can't associate it with a particular individual.

As with the content that is output to the interface according to a tagging criteria, a mechanism can be provided that allows a user to identify information that has been tagged improperly. The system can accept input that assigns a new tag to the identified information. The newly tagged information can be used to retrain one or more filters used in the system.

In 622, the system can receive indicators of content improperly tagged. In 624, the system can use the indicators and the content associated with the filter to retrain one or more filters. In some instance, the retraining can be performed each time the indicators are received. In other embodiments, the retraining can be performed on a time schedule, such as daily or weekly where all of the indicators and content received since the last training are used to retrain the filters. In yet other embodiments, retraining may be triggered when a certain number of instances have occurred. For example, each time twenty indicators of improperly tagged content are received for a particular filter, the system may retrain the particular filter.

In 626, the system can log search results, such as one or more of the person that performed the search, search parameters associated with the search, filters and filter parameters applied during the search, a list of individuals identified in the search, when the search was performed and whether the filtered data for any individuals was output. The names of the individuals whose filtered data was output can also be saved. For example, the system may provide a list of names from a search but may not display information for one of the individuals on the list until it receives a selection of the one or more of the individuals.

In 626, results such as filtered data for various individuals can be output. For example, a recruiter can perform a search based upon a specified search criterion and receive search results that include a list of names. The recruiter can then select one of the names to receive data that has been filtered in some manner, such as for protected class information. An example of filtered data can be output is described as follows with respect to FIGS. 8A and 8B.

FIGS. 8A and 8B shows an example of an interface 700 configured to display information that can be gathered and aggregated by the system for an individual and then filtered according to one or more of the methods described herein. The interface 700 includes at the top links, “My searches,” 702, “How to” 704, “Notification” 706 and “Questions or Feedback,” 708.

When selected, the link “My searches,” can cause the interface to generate interface states that allow an individual to access a number of different searches that have been carried out. When selected, the link, “How to,” 704 can cause the interface generate interface states including details of how to utilize interface 700. When selected, the link “Notifications,” 706 may cause the interface to generate a state showing a user's list of notifications. An example of notification may be messages received from someone else, such as potential candidate or a notification regarding a status of a particular candidate from the system. When selected, the link “Questions or feedback” 708 can cause the interface to generate a state that allows a user to provide feedback or ask questions to a system administrator or some other individual associated with the interface.

In one embodiment, the interface 700 can include a number of selectable tabs. A different set of information can be displayed in the interface depending on which tab is selected. In the embodiment of FIGS. 8A and 8B, five tabs are shown, “Summary” 710, “Skills” 712, “Projects” 714, “Social media” 716 and “Safe Media” 718. When selected, the “Summary” tab 710 can cause the interface to display a summary about an individual. When selected, the skills tabs 712 can cause the interface to display skills associated with individual. When selected, the “Projects” tab 714 can cause the interface to display information about projects for an individual, such as projects associated with one of their skills. For example, if one of the skills of an individual is programming, the project information may be related to a programming project. When select, the “social media” tab may include social media related information, such as links to an individual's social media profiles, such as to LinkedIn™ or FaceBook™. Further, profile information obtained from the social media sites can be displayed.

In FIGS. 8A and 8B, the safe media tab 718 has been selected and the safe media information is displayed. The safe media information can refer to information that is considered safe for use in a hiring decision. For example, the information may have been filtered according to the one or more filters previously described, such as a filter for protected class information. In one embodiment, based upon, information received from or gathered for an individual, a psychological profile 720. The psychological profile 720 can include a profile type 722 and a description 724 of the type. In one embodiment, a Myers-Briggs psychological profile can be generated. Indicators 726 associated with a Meyer-Briggs analysis are displayed. The indicators are supposed to indicate a relative tendency towards each of the word pairs, such as whether the person is an introvert or extrovert or whether the person is a feeling or thinking type person.

In another embodiment, a person's writing style can be analyzed. A writing style 728 is shown. In this example, a tendency towards a formal or more personal writing style is indicated. Additional details of psychological analysis and other information that can be included in a Safe Media tab 718 are described in U.S. patent application Ser. No. 13/652,749, entitled, “METHOD, APPARATUS AND COMPUTER PROGRAM PRODUCT TO GENERATE PSYCHOLOGICAL, EMOTIONAL, AND PERSONALITY INFORMATION FOR ELECTRONIC JOB RECRUITING,” filed Oct. 16, 2012, which is incorporated by reference in its entirety and for all purposes.

In one embodiment, the interface can be configured to tabulate a recurrence of particular words or combinations of words that appear in the social media data that has been gathered for a user. In the interface 700, a recurrence of single words 730 and word pairs (i.e., bigrams) 734 is displayed. The relative frequency of the occurrence of single words 732 or bigrams 736 is displayed such that more frequently appearing words appear larger than less frequently appearing words. In other embodiments, a numerical value can be displayed next to each word to indicate there appearance frequency. In particular embodiments, the particular words or word pairs can be filtered for compliance with legal hiring practices. For example, words or word pairs related to protected classes, such as words associated with religion, race or medical conditions may be removed before they are displayed on the interface.

In another embodiment, recurrent topics 738 can be tabulated that appear in the aggregated data can be displayed. In 700, the topics computers, business, home, society, games, recreations, arts, health, sports, science, cat, cars and cooking are displayed. The topics are sized to indicate a relative frequency of their occurrence. The topics can be selected to be safe for use in a hiring a decision. Thus, unsafe topics, such as topics that may indicate a protected class status, may not be used.

In yet other embodiments, tweets 742 and blog entries 744 generated by a user and gathered by the system can be displayed. The tweets and blog posts are referred to as safe tweets because one or more filters may have been applied so that only tweets and blog posts including information safe for use in a hiring decision are utilized. However, as described above, the filters may not be perfect. Hence, information that may be considered unsafe by a particular company or individual can be flagged and removed. The tagged information can be used to retrain filters to catch such information in the future.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, magnetic tape and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed is:

1. A method of electronic job recruiting in a system including a processor and memory, the method comprising:
training by the processor one or more filters to identify safe data, unsafe data or combinations thereof wherein the safe data is selected to be safe to use in a hiring decision;
receiving by the processor hiring data from a plurality of data sources for a plurality of individuals wherein the hiring data includes resume data and social media data;
aggregating by the processor the received hiring data for each individual;
storing by the processor the aggregated hiring data for each individual to a database , wherein the individual's aggregated hiring data includes a plurality of different portions;
receiving by the processor search parameters associated with a hiring decision;
based upon the search parameters, locating by the processor at least one individual in the database that satisfy the search parameters;
applying by the processor the one or more filters to each portion of the at least one individual's aggregated hiring data to identify safe or unsafe portions of the data; and
outputting by the processor only the safe portions.

2. The method of claim 1 wherein the social media data includes content generated by an individual and posted to a social media site wherein the content is not generated as part of applying for a particular job in a job application process.

3. The method of claim 1 wherein the resume data includes content generated by an individual and submitted as part of applying for a particular job in a job application process.

4. The method of claim 1 wherein at least one of the filters is configured to identify data associated with a federally defined protected class in the United States of America wherein the data identified as associated with the federally defined protected is considered unsafe data and is not output by the system.

5. The method of claim 1 further comprising receiving an input of a location associated with the hiring decision;
based upon the input of the location, determining a plurality of different types of data considered to be unsafe to use in the hiring decision at the location;
selecting one or more filters to identify the plurality of different types of data;
applying the selected one or more filters to the individual's aggregated hiring data.

6. The method of claim 5, wherein the location is a state in the United States of America.

7. The method of claim 1, further comprising receiving information that identifies a company;
determining a plurality of different types of data considered to be unsafe to use in the hiring decision for the company;
selecting one or more filters to identify the plurality of different types of data; and
applying the selected one or more filters to the individual's aggregated hiring data.

8. The method of claim 1, wherein the one or more filters are applied to each portion to determine a probability of whether each portion is safe or unsafe to output.

9. The method of claim 8, further comprising receiving a probability threshold and based upon the received probability threshold, determining whether each portion is safe or unsafe to output.

10. The method of claim 1, further comprising receiving an indication that a first portion of the aggregated individual's data identified as safe by the one or more filters is unsafe.

11. The method of claim 10, based upon the indication removing the first portion from the output and preventing the first portion from subsequently being output.

12. The method of claim 10, based upon the indication retraining the one or more filters.

13. The method of claim 1, further comprising retrieving the social media data from one or more different social media sites.

14. The method of claim 13, further comprising periodically checking the social media sites to determine whether new social media data is available and updating the aggregated hiring data in the database when new social media data is available including deleting old social media data.

15. The method of claim 1, wherein the individual's aggregated hiring data includes images and further comprising applying the one or more filters to determine whether each of the images is safe or unsafe to use in the hiring decision and outputting only the safe images.

16. The method of claim 1, further comprising determining a frequency at which particular words or combinations of words appear in the individual's aggregated hiring data, applying the one or more filters to the particular words or combinations of words to determine whether each one is safe or unsafe to use in a hiring decision and outputting only the particular words or combinations of words determined to be safe.

17. The method of claim 1, wherein the social media data in the at least one individual's aggregated hiring data includes tweets, applying the one or more filters to each tweet to determine whether each tweet is safe or unsafe to use in the hiring decision and outputting only the safe tweets.

18. The method of claim 1, wherein the social media data in the at least one individual's aggregated hiring data includes blog posts, applying the one or more filters to each blog post to determine whether each blog post is safe or unsafe to use in the hiring decision and outputting one the safe blog posts.

19. The method of claim 1, further comprising receiving a request to output one or more portions determined to be unsafe for use in the hiring decision and prior to outputting the one or more portions, anonymizing the one or more portions to prevent the one or more portions from being associated with a particular individual.

20. The method of claim 1, further comprising receiving an input indicating a stage in the hiring process and based upon the input stage, selecting one or more filters to apply to the individual's aggregated hiring data wherein types of data considered to be safe or unsafe to use in the hiring decision varies depending on the stage of the hiring process.

21. The method of claim 1, further comprising storing a log of the search including names of individuals identified in the search, an identifier of the person performing the search and information regarding the one or more filters used to identify data that is safe or unsafe to use in a hiring decision.

22. The method of claim 21, further comprising storing an indication of whether the safe portions were viewed or not viewed for each of the individuals identified in the search.

23. A tangible computer readable medium for storing computer code executed by a processor to generate a method of job recruiting, the computer readable medium comprising:
computer code for training one or more filters to identify safe data, unsafe data or combinations thereof wherein the safe data is selected to be safe to use in a hiring decision;
computer code for receiving hiring data from a plurality of data sources for a plurality of individuals wherein the hiring data includes resume data and social media data;
computer code for aggregating the received hiring data for each individual;
computer code for storing the aggregated hiring data for each individual to a database , wherein the individual's aggregated hiring data includes a plurality of different portions;
computer code for receiving search parameters associated with a hiring decision;
computer code, based upon the search parameters, for locating at least one individual in the database that satisfy the search parameters;
computer code for applying the one or more filters to each portion of the at least one individual's aggregated hiring data to identify safe or unsafe portions of the data; and
computer code for outputting only the safe portions.
